(19) United States
(12) Patent Application Publication
(10) Pub. No.: US 2015/0298032 A1
(43) Pub. Date: Oct. 22, 2015

(54) DRY FORMED FILTERS AND METHODS OF MAKING THE SAME

(71) Applicant: GUSMER ENTERPRISES INC., Waupaca, WI (US)

(72) Inventors: Robert L. Tinkham, Appleton, WI (US); Robert Menzies, Waupaca, WI (US)

(21) Appl. No.: 14/323,421

(22) Filed: Jul. 3, 2014

Related U.S. Application Data
(63) Continuation of application No. PCT/US14/40842, filed on Jun. 4, 2014.
(60) Provisional application No. 61/981,663, filed on Apr. 18, 2014.
(60) Provisional application No. 62/007,478, filed on Jun. 4, 2014.
(60) Provisional application No. 61/981,663, filed on Apr. 18, 2014.

(51) Int. Cl. B01D 29/56

(52) U.S. Cl. CPC B01D 29/56

(57) ABSTRACT

The disclosure includes, in some embodiments, a filter element that includes a first porous outer layer formed from a nonwoven material, a second porous outer layer formed from a nonwoven material, and at least one inner porous layer formed from a high loft nonwoven material (or other suitable material) disposed between the first porous outer layer and the second porous outer layer. The high loft nonwoven material has a three dimensional matrix formed by entangled and bonded fibers that cooperate to form a plurality of three dimensional interstices between the fibers for maintaining an open and tortuous flow path for fluid to pass through. The filter element also includes filter aid particles dispersed in the interstices of the high loft nonwoven material.

### CROSS-REFERENCE TO RELATED APPLICATIONS

This patent application is a continuation of and claims the benefit of priority to International Application No. PCT/US 14/40842, filed on Jun. 4, 2014, which in turn claims the benefit of priority to U.S. Provisional Patent Application Ser. No. 61/981,663, filed Apr. 18, 2014, U.S. Provisional Patent Application Ser. No. 62/007,478, filed Jun. 4, 2014 and U.S. Provisional Patent Application Ser. No. 61/831,769, filed Jun. 6, 2013. Each of U.S. Provisional Patent Application Ser. No. 61/981,663, filed Apr. 18, 2014 and U.S. Provisional Patent Application Ser. No. 62/007,478, filed Jun. 4, 2014 are incorporated by reference herein in their entireties for any purpose whatsoever.

### COPYRIGHT NOTICE

A portion of the disclosure of this patent document contains material which is subject to copyright protection. The copyright owner has no objection to the reproduction by anyone of the patent document or patent disclosure as it appears in the Patent and Trademark Office, patent file or records, but otherwise reserves all copyrights whatsoever.

### BACKGROUND

1. Field

The present invention relates to filters and methods of making filters.

2. Description of Related Art

Conventional wet laid depth filter media utilizes a combination of wet slurried and refined fibers, filter aids and/or adsorbents, and wet strength resins to form in a vacuum-formed wet sheet. The formed sheet is oven-dried to remove residual moisture, crosslink the wet strength resin and yield an integral, mineral-filled sheet. The method of formation of these filters requires high amounts of water, utilization of significant electrical and energy resources for dewatering and drying, and large production equipment footprints. This method of formation does not lend itself to flexible manufacturing such as easy material changeovers or thorough cleanups between dissimilar materials. Besides filter sheets, filter aids or adsorbents in cake form such as precoats or body feeds are used for filtration purposes. The cakes are formed through slurrying of the filter aids and building of the cake by retaining the filter aids on a septum or substrate. The present disclosure provides solutions for these and other problems, as described herein.

### SUMMARY OF THE DISCLOSURE

The purpose and advantages of embodiments of the present disclosure will be set forth in, and be apparent from, the description that follows, as well as will be learned by practice of the disclosed embodiments. Additional advantages of embodiments of the disclosure will be realized and attained by the methods and systems particularly pointed out in the written description and claims hereof, as well as from the appended drawings.

To achieve these and other advantages and in accordance with the purpose of the disclosed embodiments, as embodied and broadly described, in accordance with one embodiment, the disclosure includes a filter element that includes a first porous outer layer formed from a nonwoven material, a second porous outer layer formed from a nonwoven material, at least one inner porous layer formed from a high loft nonwoven material disposed between the first porous outer layer and the second porous outer layer. The high loft nonwoven material has a three dimensional matrix formed by entangled and bonded fibers that cooperate to form a plurality of three dimensional interstices between the fibers for maintaining an open and tortuous flow path for fluid to pass through. The filter element also includes filter aid particles dispersed in the interstices of the high loft nonwoven material. The first porous outer layer, second porous outer layer and the at least one inner porous layer are bonded about a perimeter to define a compartment for containing the filter aid material within the interstices of the high loft nonwoven material. In accordance with one exemplary embodiment of a filter element, the first porous outer layer can have an inner surface and an outer surface. The at least one inner porous layer can have a first surface disposed along and in direct contact with the inner surface of the first outer layer. The second porous outer layer can have an inner surface disposed along and in direct contact with second surface of the at least one inner porous layer. In some implementations, the bond can be continuous about the perimeter of the compartment. If desired, the bond can include a series of bonded areas, or such as in a plurality of locations within the perimeter to help maintain uniformity of the powder within the pouch. The bond is preferably configured to confine the filter aid particles to provide even distribution of the filter aid particles. The first porous outer layer and/or the second porous outer layer can be formed from a polyester nonwoven material, such as a spun-bonded nonwoven material. The filter aid particles can include one or more of (i) a diatomaceous earth material, (ii) an adsorbent material, and (iii) a silicate material, such as magnesium silicate. If desired, the filter aid particles can form more than eighty percent of the weight of the filter element.

In further accordance with the disclosure, a lenticular filter stack is provided including a filter element as described herein, as well as a self-enclosed filter including a filter element as described herein. The disclosure also provides a capsule filter including a filter element as described herein, as well as a spun wound filter cartridge including a filter element as described herein. The disclosure also provides a pleated filter cartridge including a filter element as described herein. The pleated filter cartridge can be formed from a plurality of pleats. Each pleat can include one or more compartments for containing the filter aid material within the interstices of the high loft nonwoven material. In some embodiments, the pleats can be arranged into a cylindrical configuration surrounding and defining a cylindrical volume, and further wherein the pleats can be parallel to a central axis of the cartridge. The disclosure further provides an edible oil depth filter including a filter element as disclosed herein for filtering edible oil. The filter element, in turn can include one or more of (i) a filter aid and (ii) an adsorbent. For example, the filter element can include activated carbon. In a further embodiment, the filter element can include at least one blended filter aid composition.

In some embodiments, the at least one inner porous layer can include a high-loft multi-ply spunbond polyester nonwoven. The at least one inner porous layer can have a nominal thickness of 0.25 inches, for example. If desired, the filter element can include a series of layers of substrates and at least one of (i) a filter aid and (ii) an adsorbent. In further embodiments, the filter element can include a plurality of inner porous layers. Each of the inner porous layers can include at least one filter aid material.

The disclosure also provides a filter element. The filter element includes a first porous outer layer formed from a nonwoven material, second porous outer layer formed from a nonwoven material, at least one porous inner layer disposed between the first porous outer layer and the second porous outer layer. The at least one porous inner layer can have a three dimensional matrix formed by entangled fibers that cooperate to form a plurality of three dimensional interstices between the fibers to maintain an open and tortuous flow path through the filter element for fluid to traverse. The filter element also includes filter aid particles dispersed in the interstices of the at least one porous inner layer. The first porous outer layer and second porous outer can be bonded about a perimeter to define a compartment for containing the at least one porous inner layer and for containing the filter aid particles within the interstices of the at least one porous inner layer.

In some embodiments, the at least one porous inner layer can include loose fibers, which can in turn include natural and/or synthetic fibers. The at least one porous inner layer can include a layered spunbound composite material. The at least one porous inner layer can include one or more of a needlepunched web material, a hydroentangled web material, a felt material, a scrim material, and a netting material. If desired, the filter element can include at least one calcined metallic oxide. If desired, the filter element can include at least one blended filter aid composition.

In one embodiment, a liquid filter is provided including a filter element as described herein. The filter element of the liquid filter can include at least one of (i) a filter aid and (ii) an adsorbent. In some embodiments, the liquid filter includes activated carbon.

If desired, the filter aid particles can form, for example, more than about seventy five percent of the weight of the filter element, more than about eighty percent of the weight of the filter element, more than about eighty five percent of the weight of the filter element, or more than about ninety percent of the weight of the filter element, or any increment between these values of about one weight percent.

In some implementations, the high loft nonwoven material of the filter element can be a polyester high loft nonwoven material.

In accordance with further embodiments, the bond can be continuous or discontinuous about the perimeter of the compartment. If desired, the first porous outer layer, second porous outer layer and the at least one inner porous layer can be further bonded in a plurality of bonding locations within the perimeter to help maintain uniformity of the powder within the pouch. The plurality of bonding locations within the perimeter can include, for example, one or more of (i) a plurality of point bonds across the area defined by the perimeter, (ii) a plurality of linear bonds across the area defined by the perimeter, (iii) continuous or discontinuous bonds forming a grid pattern within the perimeter, (iv) rows of offset dots within the perimeter, (v) continuous or discontinuous bonds forming a pattern of repeating hexagons within the perimeter. Any desired pattern can be formed, for example, with solid lines, dashed lines, dotted lines, and combinations thereof. For example, a bond pattern can be formed within the perimeter from rows of offset dashes along three different orientations. The rows of dashes can be angularly offset from each other, such as by about sixty degrees, or any other desired angle. In another embodiment, the bonding locations within the perimeter can be formed by rows of serpentine shapes. If desired, the serpentine shapes can be arranged in a herringbone-like pattern.

In some implementations, the filter element can have a pore size gradient across its thickness from an outer region of the filter to an inner region of the filter. For example, the average pore size in an outer layer of the filter can be larger than an average pore size of an inner layer of the filter. For example, the average pore size of the first porous outer layer can thus be larger than the average pore size of the second porous outer layer, such as to capture large particles in the first porous outer layer first, permitting the second porous outer layer to capture smaller particles.

In some embodiments, the filter element can include a plurality of inner layers disposed between the first porous outer layer and second porous outer layer. If desired, two adjacent inner layers can be separated by a separation layer including a sheet of porous nonwoven material. Two or more of the inner layers can be provided with differing filter aid materials. In some implementations, the separation layer can include an average pore size that is smaller than the average particle size of filter aid materials in the at least two inner layers.

In some implementations, the filter aid particles can have a tendency to become attracted to the entangled and bonded fibers of the high loft nonwoven material. If desired, the entangled and bonded fibers of the high loft nonwoven material can have an average diameter between about ten microns and about fifty microns. In another embodiment, the entangled and bonded fibers of the high loft nonwoven material can have an average diameter between about twenty microns and about forty microns. If desired, the entangled and bonded fibers of the high loft nonwoven material have an average diameter of about thirty microns.

Preferably, the filter aid particles have an average diameter based on the volume of the particles that is about equal to or smaller than the average diameter of the entangled and bonded fibers of the high loft nonwoven material. In some embodiments, a portion of the filter aid particles can be substantially spherical in shape. The filter aid particles can include a silicate, such as magnesium silicate. By way of further example, a portion of the filter aid particles can include a silicon-based filter aid material, such as diatomaceous earth (e.g., calcined diatomaceous earth).

In accordance with further aspects, the nonwoven material of the first porous outer layer can be formed from a mixture of a first group of polymeric fibers having a first average diameter and a second group of polymeric fibers having a second average diameter that is substantially larger than the first average diameter. For example, the second average diameter can be between about five microns and about eighty microns in any desired increment of about one micron, such as between about twenty microns and about forty microns, or can be about thirty microns, for example. Moreover, the first average diameter can be between about two microns and about forty microns in any increment of about one micron, such as about ten microns, for example.

In some implementations, the high-loft nonwoven material can have a nominal thickness prior to being encased between the outer layers between, for example, about 0.125 inches and about 0.5 inches, for example, such as about 0.25 inches. By way of further example, the nominal thickness of the high-loft nonwoven material can be between about 0.1 and to inches in any desired increment of 0.05 inches. The three dimensional interstices between the fibers of the high loft nonwoven material can have an average dimension between about 75 microns and about 700 microns, or any value therebetween in increments of about five microns.

In some implementations, the first porous outer layer and second porous outer layer of the filter element can be under tension imparted by compression of the high loft non-woven material of the at least one inner layer. The compression of the high loft non-woven material can result in a filter element that is thinner than the nominal thickness of the high loft non-woven material. For example, the filter element can have an overall thickness that can be less than about ninety five percent, ninety percent, eighty five percent, eighty percent, seventy five percent, or seventy percent of the nominal thickness of the high-loft nonwoven material. The high loft non-woven material can be compressed to between about ten and ninety five percent of its nominal thickness in the resulting filter element, in any desired increment of about one percent. At least one of the first porous outer layer and the second porous outer layer can have a nominal thickness between about one mil and about twenty mils in any desired increment of about one mil. In a further embodiment, the thickness can be between about three mils and about twelve mils.

The high-loft nonwoven material can have a basis weight, for example, between about 2.0 oz/yd² and about 10.0 oz/yd² in any desired increment of 0.1 oz/yd², for example. In some embodiments, the high-loft nonwoven material can have a basis weight between about 5.0 oz/yd² and about 8.0 oz/yd². At least one of the first porous outer layer and the second porous outer layer can have a basis weight, for example, between about 0.8 oz/yd² and about 4.00 oz/yd² in any desired increment of 0.1 oz/yd².

At least one of the first porous outer layer and the second porous outer layer can have an air permeability measured in accordance with ASTM D737-96 between about 10 cfm/ft² and about 200 cfm/ft² and in any increment therebetween of about 0.5 cfm/ft². The high loft nonwoven material can have an air permeability measured in accordance with ASTM D737-96 between about 50 cfm/ft² and about 2000 cfm/ft² and in any increment therebetween of about 1.0 cfm/ft². The filter aid particles can have a loading, for example between about 0.01 lbs./ft² and about 0.80 lbs./ft² across the high loft nonwoven material within the perimeter seal, and in any increment therebetween of about 0.01 lbs./ft².

The filter element can have a water permeability therethrough between about 0.5 gpm/ft² and about 200 gpm/ft² within the perimeter at a water temperature of 70° F. with a pressure differential of 10 psi across the filter element, and in any increment therebetween of about 0.1 gpm/ft². The disclosure similarly provides, in some implementations, an edible oil filter including a filter element having a water permeability therethrough between about 80 gpm/ft² and about 120 gpm/ft² within the perimeter at a water temperature of 70° F. with a pressure differential of 10 psi across the filter element, and in any increment therebetween of about 0.1 gpm/ft². The disclosure further provides embodiments of a coarse liquid filter including a filter element having a water permeability therethrough between about 7.5 gpm/ft² and about 140 gpm/ft² within the perimeter at a water temperature of 70° F. with a pressure differential of 10 psi across the filter element, and in any increment therebetween of about 0.1 gpm/ft².

The disclosure also provides a clarifying liquid filter including a filter element having a water permeability therethrough between about 1.60 gpm/ft² and about 9.30 gpm/ft² within the perimeter at a water temperature of 70° F. with a pressure differential of 10 psi across the filter element, and in any increment therebetween of about 0.1 gpm/ft². Moreover, the disclosure also provides a sterile pre-membrane liquid filter including a filter element having a water permeability therethrough between about 0.40 gpm/ft² and about 2.00 gpm/ft² within the perimeter at a water temperature of 70° F. with a pressure differential of 10 psi across the filter element, and in any increment therebetween of about 0.1 gpm/ft².

In some implementations, the filter element can be an edible oil filter element that removes between about 0.1% and 5.0% (and in any increment therebetween of about 0.1%) of free fatty acids present in oil circulated through the filter element under positive pressure at a rate of 0.007 (or 0.0047) liters per minute of oil per gram (lpm/g) of active filter aid particles present in the filter element, wherein the oil has between 1.0% and 2.0% of oleic acid prior to treatment.

In further implementations, the filter element can be an edible oil filter element that reduces the photometric index (P.I.) of the oil by between about 10% and about 70% (and any increment therebetween of about 1.0%) from oil circulated through the filter element under positive pressure at a rate of 0.007 (or 0.0047) liters per minute per gram (lpm/g) of active filter aid particles present in the filter element, wherein the oil has a P.I. between 50 and 55 prior to treatment.

In yet further implementations, the filter element can be an edible oil filter element that reduces the soap content to (or maintains the soap content at) a concentration of less than about 2.0, 1.5, 1.0 or 0.5 parts per million, wherein the oil is circulated through the filter element under positive pressure at a rate of 0.007 (or 0.0047) liters per minute per gram (lpm/g) of active filter aid particles present in the filter element, wherein the oil has less than about 3.0 ppm of soap content prior to treatment.

Filters are provided herein using filter elements as described herein in a variety of forms and geometries. For example, implementations of a pleated filter are provided herein including one or more filter elements as described herein. Each pleat can define at least one compartment for containing the filter aid material within the interstices of the high loft nonwoven material. The pleated filters can be provided in any desired shape or geometry, such as a conical shape, cylindrical shape, a planar shape, or any other desired shape. Insert molded filter cartridges of any desired shape (e.g., generally round, rectangular, square, oval, etc.) can be provided including a filter element as described herein wherein an insert molding is molded over the filter element, and further wherein the overmold includes fastening bosses or openings for holding the filter element in place, as well as one or more gaskets, flow passages, and the like. Spun wound filter cartridges including a strip of filter elements as described herein can be provided.

The disclosure also provides embodiments of a deep bed filter including a plurality of filter elements as described herein that are arranged in series and bonded together about a periphery. The filter elements can be bonded together via ultrasonic welding or other suitable heat bonding techniques. If desired, each filter element can include an insert molded filter cartridge, wherein the filter can be formed by joining the injection molded portion of each filter cartridge to an adjacent filter cartridge, such as via vibration welding or other suitable heat bonding techniques. In accordance with another aspect, a lenticular filter stack including a plurality of filter elements as described herein is also provided.

In various embodiments of filter elements herein, the filter aid particles that are dispersed in the interstices of the high loft nonwoven material can have an average particle size between about 0.1 microns and about five microns (or any incremental value therein of about 0.1 microns), and more preferably, between about 1.0 microns and about 2.5 microns based on the number of particles. The filter aid particles dispersed in the interstices of the high loft nonwoven material can have an average particle size between about 1.0 microns and about 110.0 microns based on the volume of the particles (or any incremental value therein of about one micron, such as 5, 10, 15, 20 or 25 microns, for example).

In some implementations, the filter aid particles have an average particle size based on the volume of the particles that can be larger than an average pore size of the first porous outer layer and second porous outer layer. For example, the filter aid particles can include diatomaceous earth and have an average particle size between 0.5 and about 5.0 microns (or any increment therebetween of about 0.1 microns) based on the number of particles and an average particle size between about 10.0 and about 50.0 microns (or any increment therebetween of about 1.0 microns) based on the volume of the particles. In some embodiments, the filter aid particles can include a silicate, such as magnesium silicate and have an average particle size between 0.5 and about 5.0 microns (or any increment therebetween of about 0.1 microns) based on the number of particles and an average particle size between about 10.0 and about 200.0 microns (or any increment therebetween of about 1.0 microns) based on the volume of the particles. In some implementations, the filter aid particles can include synthetic amorphous micronized silica hydrogel having an average particle size between 0.5 and about 5.0 microns (or any increment therebetween of about 0.1 microns) based on the number of particles and an average particle size between about 10.0 and about 50.0 microns (or any increment therebetween of about 1.0 microns) based on the volume of the particles.

In further accordance with the disclosure, the first porous outer layer can be made from a polymeric material having an intrinsic viscosity between about 0.45 g/dL and about 0.70 g/dL, such as any value therebetween in increments of 0.01 g/dL. The first porous outer layer can be made from a polymeric material having a heating crystallization exotherm peak temperature (T_{CH}) between about 120° C. and about 140° C. (or any value therebetween in increments of 1.0° C.) at a heating rate of 10° C. per minute as measured by differential scanning calorimetry after heating and crash cooling the sample to render it in a substantially amorphous state. The first porous outer layer can be made from a polymeric material having a cooling crystallization exotherm peak temperature (T_{CC}) between about 190° C. and about 210° C. (or any value therebetween in increments of 1.0° C.) at a cooling rate of 10° C. per minute as measured by differential scanning calorimetry. The first porous outer layer can be made at least in part from a polymeric material having a melting temperature (T_{M}) between about 245° C. and about 255° C. (or any value therebetween in increments of 1.0° C.) at a heating rate of 10° C. per minute as measured by differential scanning calorimetry. The first porous outer layer can be made at least in part from a polymeric material having a melting temperature (T_{M}) between about 200° C. and about 225° C. (or any value therebetween in increments of 1.0° C.) at a heating rate of 10° C. per minute as measured by differential scanning calorimetry. The first porous outer layer can be made from a polymeric material having a glass transition temperature (T_{g}) between about 50° C. and about 80° C. (or any value therebetween in increments of 1.0° C.) at a heating rate of 10° C. per minute as measured by differential scanning calorimetry after heating and crash cooling the sample to render it in a substantially amorphous state. Alternatively, the first porous outer layer can be made from a polymeric material having a glass transition temperature (T_{g}) between about 50° C. and about 60° C. at a heating rate of 10° C. per minute as measured by differential scanning calorimetry in a native state.

In still further accordance with the disclosure, the high loft nonwoven material can be made from a polymeric material having a heating crystallization exotherm peak temperature (T_{CH}) between about 120° C. and about 140° C. (or any value therebetween in increments of 1.0° C.) at a heating rate of 10° C. per minute as measured by differential scanning calorimetry after heating and crash cooling the sample to render it in a substantially amorphous state. If desired, the high loft nonwoven material can be made from a polymeric material having a cooling crystallization exotherm peak temperature (T_{CC}) between about 200° C. and about 220° C. (or any value therebetween in increments of 1.0° C.) at a cooling rate of 10° C. per minute as measured by differential scanning calorimetry. The high loft nonwoven material can be made from a polymeric material having a melting temperature (T_{M}) between about 245° C. and about 255° C. (or any value therebetween in increments of 1.0° C.) at a heating rate of 10° C. per minute as measured by differential scanning calorimetry. The high loft nonwoven material can be made from a polymeric material having a glass transition temperature (T_{g}) between about 60° C. and about 90° C. (or any value therebetween in increments of 1.0° C.) at a heating rate of 10° C. per minute as measured by differential scanning calorimetry after heating and crash cooling the sample to render it in a substantially amorphous state. If desired, the high loft nonwoven material can be made from a polymeric material having a glass transition temperature (T_{g}) between about 80° C. and about 115° C. (or any value therebetween in increments of 1.0° C.) at a heating rate of 10° C. per minute as measured by differential scanning calorimetry in a native state.

In further accordance with the disclosure, the first outer porous layer can be formed from fibers of polyethylene terephthalate. If desired, the fibers of polyethylene terephthalate material forming the first outer porous layer can include between about 2 and about 10 mole percent comonomer substitution, or any value therebetween in increments of about 0.1 mole percent. The comonomer substitution can include a diacid component and a diol component. The diol component can include at least one of diethylene glycol and tetramethylene glycol. The diacid component can include one or more of adipic acid and isophthalic acid. The diol component can include, for example, one or more of diethylene glycol, polyethylene glycol and polypropylene glycol, wherein between about 1.0 and about 10.0 mole percent of the diol component of the fibers of polyethylene terephthalate material includes one or more of such diol components, or any value therebetween in increments of about 0.1 mole percent.

The high loft nonwoven material can be formed from fibers of polyethylene terephthalate. If desired, the fibers of polyethylene terephthalate material of the high loft nonwoven material can include between about 2 and about 10 mole percent comonomer substitution, or any value therebetween in increments of about 0.1 mole percent. The comonomer substitution can include a diacid component and a diol component. The diol component can include at least one of diethylene glycol and tetramethylene glycol. The diacid component can include one or more of adipic acid and isophthalic acid. The diol component can include, for example, one or more of diethylene glycol, polyethylene glycol and polypropylene glycol, wherein between about 1.0 and about 10.0 mole percent of the diol component of the fibers of polyethylene terephthalate material includes one or more of such diol components, or any value therebetween in increments of about 0.1 mole percent.

One or more of the first outer porous layer and the high loft nonwoven layer can be formed from a polymer including at least one of (i) elemental sodium, (ii) elemental phosphorus, (iii) elemental antimony, (iv) elemental titanium, (v) elemental zinc, (vi) elemental aluminum, (vii) elemental calcium, (viii) elemental cobalt, (ix) elemental iron, (x) elemental potassium, and (xi) elemental magnesium. For example, the polymer can include between about 20 and about 50 ppm of elemental sodium (or any incremental value therebetween of 1.0 ppm), between about 10 and about 30 ppm of elemental phosphorus (or any incremental value therebetween of 1.0 ppm), between about 200 and about 280 ppm of elemental antimony (or any incremental value therebetween of 1.0 ppm), between about 1000 and about 1300 ppm of elemental titanium (or any incremental value therebetween of 1.0 ppm), between about 2 and about 20 ppm of elemental zinc (or any incremental value therebetween of 1.0 ppm), between about 2 and about 20 ppm of elemental aluminum (or any incremental value therebetween of 1.0 ppm), between about 2 and about 30 ppm of elemental calcium (or any incremental value therebetween of 1.0 ppm), between about 2 and about 20 ppm of elemental cobalt (or any incremental value therebetween of 1.0 ppm), between about 2 and about 20 ppm of elemental iron (or any incremental value therebetween of 1.0 ppm), between about 10 and about 30 ppm of elemental potassium (or any incremental value therebetween of 1.0 ppm), and/or between about 2 and about 20 ppm of elemental magnesium (or any incremental value therebetween of 1.0 ppm). In further implementations, the polymer can include between about 100 and about 500 ppm of elemental sodium (or any incremental value therebetween of 1.0 ppm), between about 60 and about 100 ppm of elemental phosphorus (or any incremental value therebetween of 1.0 ppm), between about 250 and about 350 ppm of elemental antimony (or any incremental value therebetween of 1.0 ppm), between about 1000 and about 1300 ppm of elemental titanium (or any incremental value therebetween of 1.0 ppm), between about 2 and about 20 ppm of elemental zinc (or any incremental value therebetween of 1.0 ppm), between about 2 and about 20 ppm of elemental aluminum (or any incremental value therebetween of 1.0 ppm), between about 2 and about 30 ppm of elemental calcium (or any incremental value therebetween of 1.0 ppm), between about 2 and about 20 ppm of elemental cobalt (or any incremental value therebetween of 1.0 ppm), between about 2 and about 20 ppm of elemental iron (or any incremental value therebetween of 1.0 ppm), between about 10 and about 200 ppm of elemental potassium (or any incremental value therebetween of 1.0 ppm), and/or between about 2 and about 20 ppm of elemental magnesium (or any incremental value therebetween of 1.0 ppm).

It is to be understood that both the foregoing general description and the following detailed description are exemplary and are intended to provide further explanation of the disclosed embodiments. The accompanying drawings, which are incorporated in and constitute part of this specification, are included to illustrate and provide a further understanding of the methods and systems and devices of the present disclosure. Together with the description, the drawings serve to explain the principles of the disclosed embodiments.

### BRIEF DESCRIPTION OF THE DRAWINGS

FIG. 1 is a schematic drawing of an illustrative filter element in accordance with the present disclosure.

FIG. 2 is schematic drawing of an illustrative filter element in accordance with the disclosure having a layered construction with joined areas to create filter zones.

FIG. 3 is a schematic drawing of a filter including a filter element in accordance with the present disclosure in spiral and pleated configuration.

FIG. 4 is a photomicrograph of an illustrative porous outer layer material for a filter element in accordance with the disclosure.

FIG. 5 is a photomicrograph of an illustrative inner layer material for a filter element in accordance with the disclosure.

FIG. 6 illustrates the inner layer material of FIG. 5 with a first filter aid deposited on it.

FIG. 7 illustrates the inner layer material of FIG. 5 with a second filter aid deposited on it different from that illustrated in FIG. 6.

FIGS. 8A-8G illustrate various seal line patterns for filter elements in accordance with the present disclosure.

FIG. 9 is an illustration of a plurality of insert molded filter elements in accordance with the disclosure.

FIG. 10 is an illustration of a deep bed filter including a plurality of insert molded filter elements in accordance with the disclosure.

FIG. 11A is an illustration of a lenticular filter stack including a plurality of cells including filter elements in accordance with the disclosure.

FIG. 11B is a cutaway view of the lenticular filter stack of FIG. 11A.

FIG. 11C is a cutaway view of a cell of the lenticular filter stack of FIG. 11A.

FIG. 12 is an illustration of a filter element in accordance with the disclosure having a pore size or porosity gradient across its cross section.

FIG. 13 is a multi-layer filter element in accordance with the disclosure.

FIG. 14 is an illustration of compression of the components of an exemplary filter element in accordance with the disclosure during assembly.

FIG. 15 illustrates a filter element sample holder in accordance with the disclosure used for filter performance testing in accordance with the disclosure.

FIG. 16 is a schematic representation of a procedure for filter performance testing in accordance with the disclosure using the filter element sample holder illustrated in FIG. 15.

### DETAILED DESCRIPTION OF PREFERRED EMBODIMENTS

Reference will now be made in detail to the present preferred embodiments of the disclosure, examples of which are illustrated in the accompanying drawings. The methods and corresponding steps of the disclosure will be described in conjunction with the detailed descriptions of the preferred embodiments.

In one aspect, the present disclosure is directed to more efficient and flexible filters and associated manufacturing methods for making the same that eliminate water usage for slurrying or refining, energy requirements for refining, vacuum formation and/or sheet drying. Since the use of wet slurrying in water or other solvents can be eliminated, the technique can allow the use of water soluble filter aids or additives to assist in non-aqueous filtration cycles for contaminant removal. A further advantage is the resulting filter provides a useful format for additional processing such as device assembly including winding, pleating or insert injection molding. Still a further advantage is that the resulting filter article has similar properties and performance to conventional media for liquid applications. The resulting filter articles can be provided with a filter aid or blended filter aid composition, and can be provided in an easy-to-use format having attributes that are more desirable than filter cakes. Some implementations of the filter articles can be provided with suitable adsorbent chemistries or affinities with additional materials in an interior (e.g., middle) layer to allow for improved contact, porosity and less filter aid agglomeration. These combined layers, along with bonding or stitching of the layers, confine the interior materials, permitting relatively equal distribution of materials within a given surface area and less material migration or stratification in the product, resulting in consistent porosity and filtration performance.

In another aspect, the present disclosure is directed to filters for filtering waste materials from a fluid. In an exemplary embodiment, the filter is formed of an outer pocket that can be formed from two bonded substrate layers (such as a nonwoven material). The pocket, in turn, can then be provided with a filter material. The material for forming the substrate layers is selected depending on the choice of the filter material disposed between the layers, which may include a particulate material having a particular particle size distribution, and based on the desired composite porosity. The filter material preferably includes material that is sufficient to maintain an open flow path for the filtered fluid to pass through, and sufficient to provide adequate surface area and a suitably torturous path for the fluid to pass through to remove contaminants from the fluid.

The substrate layers can be bonded together, such as by ultrasonic welding, stitching, adhesives via heat sealing or cold sealing, calendering, and needlepunching, among other suitable techniques.

The disclosure similarly provides processes for producing a depth filter using dry formation methods for producing filter elements for use in filtration and adsorptive applications. The resulting filter element product includes a series of layers of substrates and filter aids and/or adsorbent materials to build depth, create porosity and provide a matrix to hold filter aids and/or adsorbent particles. Selection of the layers and particle aids can be determined by particle size distribution, balancing flow characteristics of the filter and the retention of the particles in the filter. Processing conditions and desired removal properties can also be factors in selecting materials for chemical affinity, compatibility and thermal stability. The finished depth filter product can be assembled using stitching, bonding or lamination methods to produce an integral depth filter product that can be used singly or in a layered filter construction, such as in sheet, stack, wound or pleated filter formats. Various embodiments of the depth filters described herein can be used as a flow-through filter.

Unlike conventional depth filters, various implementations of filter elements provided by the disclosure can accommodate high filter aid loadings without sacrifice of tensile strength. For example, it is typical for “wet laid” filters as described above to be limited to about 60-70% powder loadings by weight due to low strength and powder retention issues. In some implementations, the use of a high-loft nonwoven in the filter keeps the filter open enough to allow for a useful magnitude of flow through the filter. Using a nonwoven polymeric material facilitates the use of ultrasonic welding or other suitable heat bonding techniques rather than sewing, which in turn removes the need for thread and provides a bond without puncturing the surface of the filter itself.

In view of the foregoing, illustrative embodiments herein, and aspects thereof, are described below.

Outer Substrate Materials:

In accordance with the disclosure, a filter element is provided that includes a first porous outer layer formed from a nonwoven material, and a second porous outer layer formed from a nonwoven material. The outer substrate materials can be made from the same material.

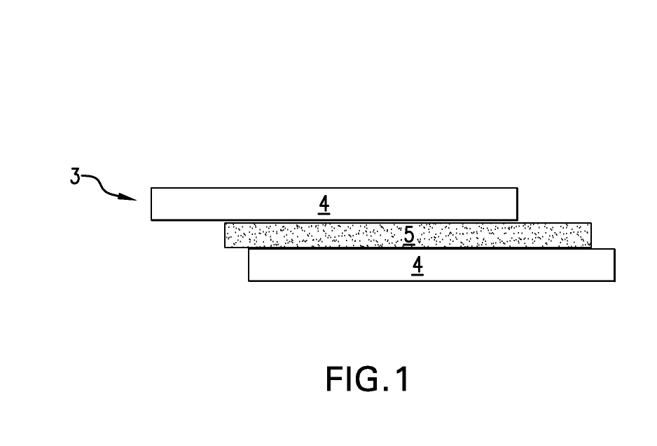

For purposes of illustration, and not limitation, FIG. 1 presents an exemplary layered construction of a filter element in accordance with the disclosure. As illustrated, the filter element includes first and second porous outer layers 4 that surround an inner layer 5 including one or more inner materials. As described herein, two outer substrate layers 4 are used in various embodiments to retain materials used in one or more inner layers 5. The selection of the outer layers can be made on the choice of materials disposed between the two outer substrate layers. For example, the particle size and particle distribution of any particulate material can be considered, as well as a desired composite porosity of the filter after assembly.

The outer substrate layers can include synthetic and/or natural materials, including but not limited to a polyester nonwoven material, such as a spunbond nonwoven material. Materials for the substrate layers can similarly include synthetic and/or natural materials, such as polyester, polypropylene, polyethylene terephthalate (“PET”), nylon, polyurethane, polybutylene terephthalate, polylactic acid, phenolic, acrylic, polyvinyl acetate, wood pulp, cotton, regenerated cellulose (i.e. rayon, lyocell), jute, grass fibers, glass fibers, and the like. These fibers can be formed into sheets or webs in various ways. For example, any desired nonwoven processes can be used (e.g., meltblowing, spunbonding, wet-laying, air-laying, needlepunching, electrospinning), as well as standard papermaking practices, similar to wet-laid nonwoven processes. In addition, the fibers can be woven using standard textile production techniques. Preferably, the outer substrate layers define pores therethrough that are small enough to substantially contain any powdered filter aid materials and the like.

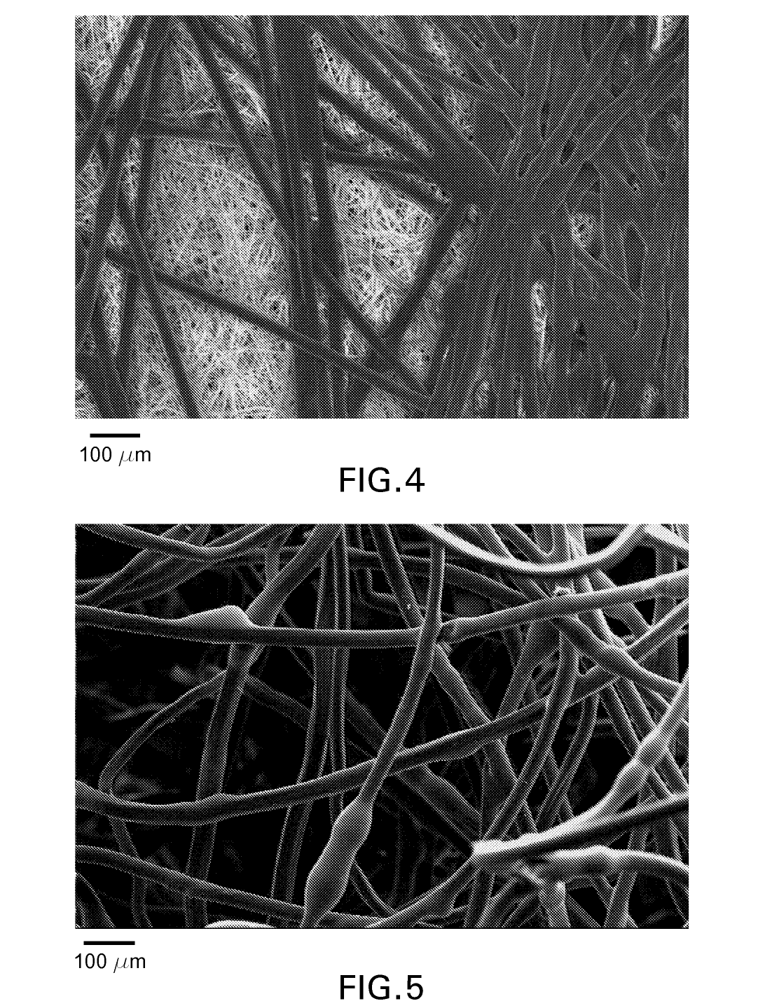

In accordance with further aspects, the nonwoven material of the first porous outer layer can be formed from a mixture of a first group of polymeric fibers having a first average diameter and a second group of polymeric fibers having a second average diameter that is substantially larger than the first average diameter. For example, the second average diameter can be between about five microns and about eighty microns in any desired increment of about one micron, such as between about twenty microns and about forty microns, or can be about thirty microns, for example. Moreover, the first average diameter can be between about two microns and about forty microns in any increment of about one micron, such as about ten microns, for example. A photomicrograph at 100× of this material is appended hereto in FIG. 4, illustrating the first group of polymeric fibers having a first average diameter and the second group of polymeric fibers having a second average diameter that is substantially larger than the first average diameter.

At least one of the first porous outer layer and the second porous outer layer can have an air permeability measured in accordance with ASTM D737-96 between about 10 cfm/ft² and about 200 cfm/ft² and in any increment therebetween of about 0.5 cfm/ft². Air permeability as discussed herein is measured in accordance with ASTM D737-96. In accordance with one implementation, the outer layers of the filter can be formed from a polyester spunbond meltblown spunbond (SMS) nonwoven web material (such as Product No. FM-200 obtained from Midwest Filtration, Cincinnati, Ohio) having a nominal thickness of 7 mil, a basis weight of 1.80 oz/yd², and an air permeability measured in accordance with ASTM D737-96 of 50 cfm/ft². A copy of ASTM D737-96 is appended to U.S. Provisional Patent Application Ser. No. 62/007,478, filed Jun. 4, 2014.

In further accordance with the disclosure, the first porous outer layer (and/or high loft nonwoven layer) can be made from a polymeric material having an intrinsic viscosity between about 0.45 g/dL and about 0.70 g/dL, such as any value therebetween in increments of 0.01 g/dL.

As used herein, the term “intrinsic viscosity” is the ratio of the specific viscosity of a polymer solution of known concentration to the concentration of solute, extrapolated to zero concentration. Intrinsic viscosity, which is widely recognized as a standard measurement of polymer characteristics, is directly proportional to average polymer molecular weight. See, e.g., Dictionary of Fiber and Textile Technology, Hoechst Celanese Corporation (1990); Tortora & Merkel, Fairchild's Dictionary of Textiles (7^{th} Edition 1996); both of which are incorporated by reference herein in their entireties.

Intrinsic viscosity can be measured and determined without undue experimentation by those of ordinary skill in this art. For the intrinsic viscosity values described herein, the intrinsic viscosity is determined by dissolving the copolyester in orthochlorophenol (OCP), measuring the relative viscosity of the solution using a Schott Autoviscometer (AVS Schott and AVS 500 Viscosystem), and then calculating the intrinsic viscosity based on the relative viscosity. See, e.g., Dictionary of Fiber and Textile Technology (“intrinsic viscosity”).

In particular, a 0.6-gram sample (+/−0.005 g) of dried polymer sample is dissolved in about 50 ml (61.0 63.5 grams) of orthochlorophenol at a temperature of about 105° C. Fiber and yarn samples are typically cut into small pieces. After cooling to room temperature, the solution is placed in the viscometer at a controlled, constant temperature, (e.g., between about 20° C. and 25° C.), and the relative viscosity is measured. As noted, intrinsic viscosity is calculated from relative viscosity.

The first porous outer layer can be made from a polymeric material having a heating crystallization exotherm peak temperature (T_{CH}) between about 120° C. and about 140° C. (or any value therebetween in increments of 1.0° C.) at a heating rate of 10° C. per minute as measured by differential scanning calorimetry after heating and crash cooling the sample to render it in a substantially amorphous state. The first porous outer layer can be made from a polymeric material having a cooling crystallization exotherm peak temperature (T_{CC}) between about 190° C. and about 210° C. (or any value therebetween in increments of 1.0° C.) at a cooling rate of 10° C. per minute as measured by differential scanning calorimetry. The first porous outer layer can be made at least in part from a polymeric material having a melting temperature (T_{M}) between about 245° C. and about 255° C. (or any value therebetween in increments of 1.0° C.) at a heating rate of 10° C. per minute as measured by differential scanning calorimetry. The first porous outer layer can be made at least in part from a polymeric material having a melting temperature (T_{M}) between about 200° C. and about 225° C. (or any value therebetween in increments of 1.0° C.) at a heating rate of 10° C. per minute as measured by differential scanning calorimetry. The first porous outer layer can be made from a polymeric material having a glass transition temperature (T_{g}) between about 50° C. and about 80° C. (or any value therebetween in increments of 1.0° C.) at a heating rate of 10° C. per minute as measured by differential scanning calorimetry after heating and crash cooling the sample to render it in a substantially amorphous state. Alternatively, the first porous outer layer can be made from a polymeric material having a glass transition temperature (T_{g}) between about 50° C. and about 60° C. at a heating rate of 10° C. per minute as measured by differential scanning calorimetry in a native state. Thermal properties can be evaluated, for example, via standard differential scanning calorimetry techniques using a differential scanning calorimeter such as a TA Q-1000 differential scanning calorimeter (user manual appended to U.S. Provisional Patent Application Ser. No. 62/007,478, filed Jun. 4, 2014). Thermal parameters as disclosed herein are to be measured in accordance with the 1997 International Standard for Differential Scanning Calorimetry of Plastics, ISO 11357 and ISO 291, entitled “Plastics—Standard atmospheres for conditioning and testing,” which defines specific temperature and humidity conditions for specimen testing (Excerpts appended to U.S. Provisional Patent Application Ser. No. 62/007,478, filed Jun. 4, 2014), or equivalent. DSC scans of samples of the FM-200 material (denoted as “Barrier Non-Woven”) and the Uniloft 675 material (denoted as “Gusmer High-Loft Non-Woven) are appended to U.S. Provisional Patent Application Ser. No. 62/007,478, filed Jun. 4, 2014.

In further accordance with the disclosure, the first outer porous layer can be formed from fibers of polyethylene terephthalate. If desired, the fibers of polyethylene terephthalate material forming the first outer porous layer can include between about 2 and about 10 mole percent comonomer substitution, or any value therebetween in increments of about 0.1 mole percent. The comonomer substitution can include a diacid component and a diol component.

The term “terephthalate component” broadly refers to diacids and diesters that can be used to prepare polyethylene terephthalate. In particular, the terephthalate component mostly includes either terephthalic acid or dimethyl terephthalate, but can include diacid and diester comonomers as well. In other words, the “terephthalate component” is either a “diacid component” or a “diester component.”

The term “diacid component” refers somewhat more specifically to diacids (e.g., terephthalic acid) that can be used to prepare polyethylene terephthalate via direct esterification. The term “diacid component,” however, is intended to embrace relatively minor amounts of diester comonomer (e.g., mostly terephthalic acid and one or more diacid modifiers, but optionally with some diester modifiers, too).

Similarly, the term “diester component” refers somewhat more specifically to diesters (e.g., dimethyl terephthalate) that can be used to prepare polyethylene terephthalate via ester exchange. The term “diester component,” however, is intended to embrace relatively minor amounts of diacid comonomer (e.g., mostly dimethyl terephthalate and one or more diester modifiers, but optionally with some diacid modifiers, too).

Moreover, as used herein, the term “comonomer” is intended to include monomeric and oligomeric modifiers (e.g., polyethylene glycol).

The diol component can include at least one of diethylene glycol and tetramethylene glycol. As used herein, the term “diol component” refers primarily to ethylene glycol, although other diols (e.g., diethylene glycol) may be used as well. The diacid component can include one or more of adipic acid and isophthalic acid. The diol component can include, for example, one or more of diethylene glycol, polyethylene glycol and polypropylene glycol, wherein between about 1.0 and about 10.0 mole percent of the diol component of the fibers of polyethylene terephthalate material includes one or more of such diol components, or any value therebetween in increments of about 0.1 mole percent.

The diol component can include other diols besides ethylene glycol (e.g., diethylene glycol, polyethylene glycol, 1,3-propanediol, 1,4-butanediol, 1,4-cyclohexane dimethanol, neopentyl glycol, and isosorbide), or the terephthalate component, in addition to terephthalic acid or its dialkyl ester (i.e., dimethyl terephthalate), can include modifiers such as isophthalic acid or its dialkyl ester (i.e., dimethyl isophthalate), 2,6-naphthalene dicarboxylic acid or its dialkyl ester (i.e., dimethyl 2,6 naphthalene dicarboxylate), adipic acid or its dialkyl ester (i.e., dimethyl adipate), succinic acid, its dialkyl ester (i.e., dimethyl succinate), or its anhydride (i.e., succinic anhydride), or one or more functional derivatives of terephthalic acid.

One or more of the first outer porous layer and the high loft nonwoven layer can be formed from a polymer including at least one of (i) elemental sodium, (ii) elemental phosphorus, (iii) elemental antimony, (iv) elemental titanium, (v) elemental zinc, (vi) elemental aluminum, (vii) elemental calcium, (viii) elemental cobalt, (ix) elemental iron, (x) elemental potassium, and (xi) elemental magnesium. For example, the polymer can include between about 20 and about 50 ppm of elemental sodium (or any incremental value therebetween of 1.0 ppm), between about 10 and about 30 ppm of elemental phosphorus (or any incremental value therebetween of 1.0 ppm), between about 200 and about 280 ppm of elemental antimony (or any incremental value therebetween of 1.0 ppm), between about 1000 and about 1300 ppm of elemental titanium (or any incremental value therebetween of 1.0 ppm), between about 2 and about 20 ppm of elemental zinc (or any incremental value therebetween of 1.0 ppm), between about 2 and about 20 ppm of elemental aluminum (or any incremental value therebetween of 1.0 ppm), between about 2 and about 30 ppm of elemental calcium (or any incremental value therebetween of 1.0 ppm), between about 2 and about 20 ppm of elemental cobalt (or any incremental value therebetween of 1.0 ppm), between about 2 and about 20 ppm of elemental iron (or any incremental value therebetween of 1.0 ppm), between about 10 and about 30 ppm of elemental potassium (or any incremental value therebetween of 1.0 ppm), and/or between about 2 and about 20 ppm of elemental magnesium (or any incremental value therebetween of 1.0 ppm). In further implementations, the polymer can include between about 100 and about 500 ppm of elemental sodium (or any incremental value therebetween of 1.0 ppm), between about 60 and about 100 ppm of elemental phosphorus (or any incremental value therebetween of 1.0 ppm), between about 250 and about 350 ppm of elemental antimony (or any incremental value therebetween of 1.0 ppm), between about 1000 and about 1300 ppm of elemental titanium (or any incremental value therebetween of 1.0 ppm), between about 2 and about 20 ppm of elemental zinc (or any incremental value therebetween of 1.0 ppm), between about 2 and about 20 ppm of elemental aluminum (or any incremental value therebetween of 1.0 ppm), between about 2 and about 30 ppm of elemental calcium (or any incremental value therebetween of 1.0 ppm), between about 2 and about 20 ppm of elemental cobalt (or any incremental value therebetween of 1.0 ppm), between about 2 and about 20 ppm of elemental iron (or any incremental value therebetween of 1.0 ppm), between about 10 and about 200 ppm of elemental potassium (or any incremental value therebetween of 1.0 ppm), and/or between about 2 and about 20 ppm of elemental magnesium (or any incremental value therebetween of 1.0 ppm). Such elemental content can be determined by standard analytical techniques, such as those employing inductively coupled plasma (“ICP”) techniques and established standards, which are well known in the art.

Inner Materials:

Inner materials are disposed within the outer layers, and can include any suitable filter material, such as natural or synthetic materials such as loose fibers, filter aids, adsorbents or blends along with scrims, woven and nonwoven materials, such as layered spunbond composites, needlepunched webs, hydroentangled webs, layers of loose fibers, felts, netting, membranes, textiles, PET nonwoven material (preferably a high-loft PET nonwoven material) and the like to maintain an open flow path for the filtered fluid to pass through.

In some implementations, the high-loft nonwoven material can have a nominal thickness prior to being encased between the outer layers between, for example, about 0.125 inches and about 0.5 inches, for example, such as about 0.25 inches. By way of further example, the nominal thickness of the high-loft nonwoven material can be between about 0.1 and 1.0 inches in any desired increment of 0.05 inches. The three dimensional interstices between the fibers of the high loft nonwoven material can have an average dimension between about 75 microns and about 700 microns, or any value therebetween in increments of about five microns.

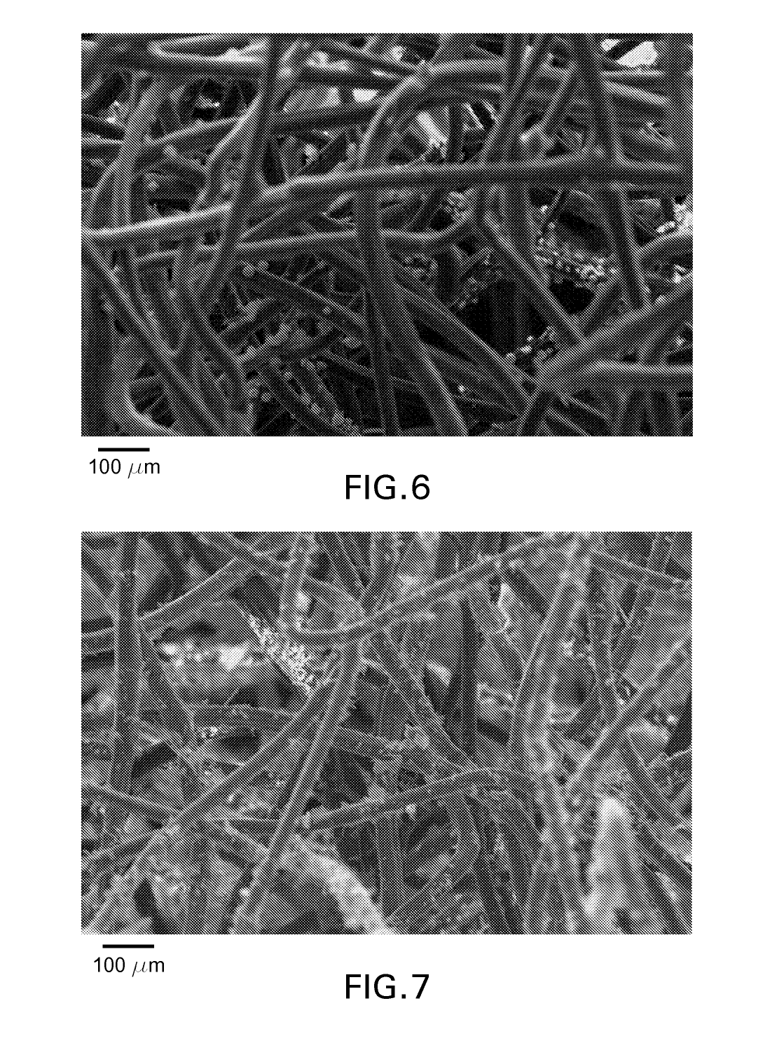

In some implementations, the filter aid particles can have a tendency to become attracted to the entangled and bonded fibers of the high loft nonwoven material, as illustrated in FIGS. 6 and 7. Specifically, illustrated in FIGS. 6 and 7 are samples of a high-loft multi-ply spunbond polyester nonwoven material (Uniloft 675, Midwest Filtration, Cincinnati, Ohio) with a nominal thickness of 0.25 inches, a basis weight of 6.75 oz/yd², and an air permeability of 800 cfm/ft². As is clearly evident, particles of magnesium silicate (FIG. 6) and diatomaceous earth (FIG. 7) are attracted to the fibers of the nonwoven material.

If desired, the entangled and bonded fibers of the high loft nonwoven material can have an average diameter between about ten microns and about fifty microns. In another embodiment, the entangled and bonded fibers of the high loft nonwoven material can have an average diameter between about twenty microns and about forty microns. If desired, the entangled and bonded fibers of the high loft nonwoven material have an average diameter of about thirty microns. An example of such a high loft non-woven material is illustrated in FIG. 5. The high loft nonwoven material can have an air permeability between about 50 cfm/ft² and about 2000 cfm/ft² and in any increment therebetween of about 1.0 cfm/ft².

In still further accordance with the disclosure, the high loft nonwoven material can be made from a polymeric material having a heating crystallization exotherm peak temperature (T_{CH}) between about 120° C. and about 140° C. (or any value therebetween in increments of 1.0° C.) at a heating rate of 10° C. per minute as measured by differential scanning calorimetry after heating and crash cooling the sample to render it in a substantially amorphous state. If desired, the high loft nonwoven material can be made from a polymeric material having a cooling crystallization exotherm peak temperature (T_{CC}) between about 200° C. and about 220° C. (or any value therebetween in increments of 1.0° C.) at a cooling rate of 10° C. per minute as measured by differential scanning calorimetry. The high loft nonwoven material can be made from a polymeric material having a melting temperature (T_{M}) between about 245° C. and about 255° C. (or any value therebetween in increments of 1.0° C.) at a heating rate of 10° C. per minute as measured by differential scanning calorimetry. The high loft nonwoven material can be made from a polymeric material having a glass transition temperature (T_{g}) between about 60° C. and about 90° C. (or any value therebetween in increments of 1.0° C.) at a heating rate of 10° C. per minute as measured by differential scanning calorimetry after heating and crash cooling the sample to render it in a substantially amorphous state. If desired, the high loft nonwoven material can be made from a polymeric material having a glass transition temperature (T_{g}) between about 80° C. and about 115° C. (or any value therebetween in increments of 1.0° C.) at a heating rate of 10° C. per minute as measured by differential scanning calorimetry in a native state.

If desired, the fibers of polyethylene terephthalate material of the high loft nonwoven material can include between about 2 and about 10 mole percent comonomer substitution, or any value therebetween in increments of about 0.1 mole percent. The comonomer substitution can include a diacid component and a diol component. The diol component can include at least one of diethylene glycol and tetramethylene glycol. The diacid component can include one or more of adipic acid and isophthalic acid. The diol component can include, for example, one or more of diethylene glycol, polyethylene glycol and polypropylene glycol, wherein between about 1.0 and about 10.0 mole percent of the diol component of the fibers of polyethylene terephthalate material includes one or more of such diol components, or any value therebetween in increments of about 0.1 mole percent. Moreover, the polymeric fibers of the high loft nonwoven material can be substantially the same as that of the outer layers, as desired.

Filter Aid Particles

If desired, the filter material can additionally or alternatively include one or more of silica or silicates, activated carbon, chitosan, diatomaceous earth, perlite, rhyolite, bauxite, zeolite, bentonite, glass beads, activated alumina, ion exchange resins/beads, superabsorbent polymer (SAP), crystalline and amorphous polymers, microcrystalline cellulose, nanocrystalline cellulose, food compatible acids (citric acid, tartaric acid, acetic acid, phosphoric acid, and malic acid), calcined metallic oxides (e.g., magnesium oxide, aluminum oxide, potassium oxide, calcium oxide, zinc oxide, ferric oxide), and granulated fruit peelings.

In further accordance with the disclosure, if desired, the filter aid particles can form, for example, more than about seventy five percent of the weight of the filter element, more than about eighty percent of the weight of the filter element, more than about eighty five percent of the weight of the filter element, or more than about ninety percent of the weight of the filter element, or any increment between these values of about one weight percent. In further embodiments, the filter aid particles can form, for example, more than about twenty percent of the weight of the filter element, more than about thirty percent of the weight of the filter element, more than about forty, fifty, sixty, seventy or eighty percent of the weight of the filter element, or any increment between these values of about one weight percent. The filter aid particles can have a loading, for example between about 0.01 lbs./ft² and about 0.80 lbs./ft² across the high loft non woven material within the perimeter seal, and in any increment therebetween of about 0.01 lbs./ft².

Preferably, the filter aid particles have an average diameter based on the volume of the particles that is about equal to or smaller than the average diameter of the entangled and bonded fibers of the high loft nonwoven material. In some embodiments, a portion of the filter aid particles can be substantially spherical in shape. The filter aid particles can include a silicate, such as magnesium silicate. By way of further example, a portion of the filter aid particles can include a silicon-based filter aid material, such as diatomaceous earth (e.g., calcined diatomaceous earth).

In various embodiments of filter elements herein, the filter aid particles that are dispersed in the interstices of the high loft nonwoven material can have an average particle size between about 0.1 microns and about five microns (or any incremental value therein of about 0.1 microns), and more preferably, between about 1.0 microns and about 2.5 microns based on the number of particles. The filter aid particles dispersed in the interstices of the high loft nonwoven material can have an average particle size between about 1.0 microns and about 110.0 microns based on the volume of the particles (or any incremental value therein of about one micron, such as 5, 10, 15, 20 or 25 microns, for example).

In some implementations, the filter aid particles have an average particle size based on the volume of the particles that can be larger than an average pore size of the first porous outer layer and second porous outer layer. For example, the filter aid particles can include diatomaceous earth and have an average particle size between 0.5 and about 5.0 microns (or any increment therebetween of about 0.1 microns) based on the number of particles and an average particle size between about 10.0 and about 50.0 microns (or any increment therebetween of about 1.0 microns) based on the volume of the particles. In some embodiments, the filter aid particles can include a silicate, such as magnesium silicate and have an average particle size between 0.5 and about 5.0 microns (or any increment therebetween of about 0.1 microns) based on the number of particles and an average particle size between about 10.0 and about 200.0 microns (or any increment therebetween of about 1.0 microns) based on the volume of the particles. In some implementations, the filter aid particles can include synthetic amorphous micronized silica hydrogel having an average particle size between 0.5 and about 5.0 microns (or any increment therebetween of about 0.1 microns) based on the number of particles and an average particle size between about 10.0 and about 50.0 microns (or any increment therebetween of about 1.0 microns) based on the volume of the particles. Particle size scans of examples of such filter aids are appended to U.S. Provisional Patent Application Ser. No. 62/007,478, filed Jun. 4, 2014.

Bonding of Layers

The outer layers are bonded to each other (preferably through and to any interior layers) via any suitable bonding, stitching or adhesive techniques via heat sealing or cold sealing, calendering, and needlepunching. The bonding results in the confinement of materials between the outer substrate layers, providing even, or substantially even distribution of any filter aids or absorbents per given surface area. The combined material layers may be bonded, die cut or formed in a variety of shapes or sizes and assembled into other final filtration devices.

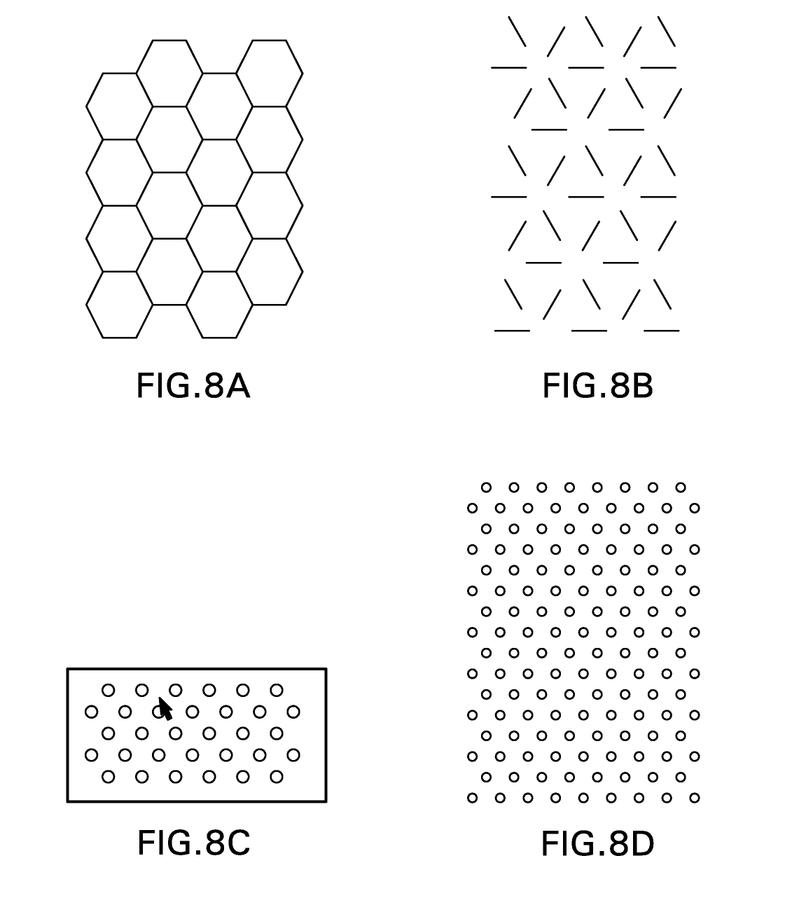

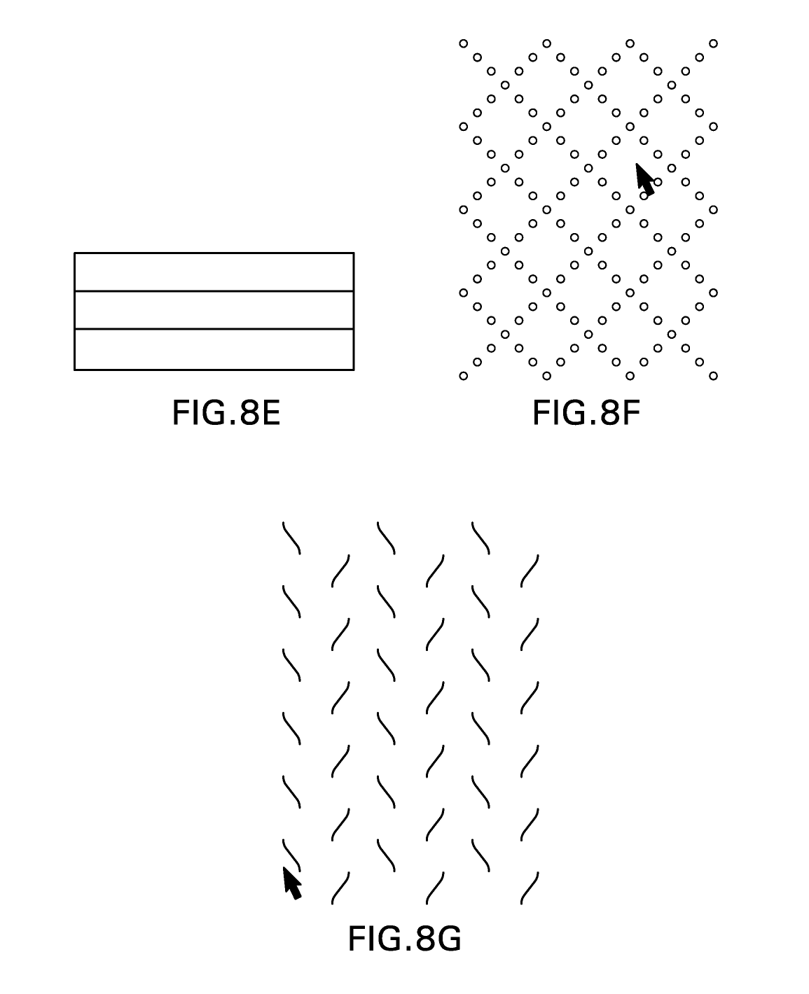

In accordance with further embodiments, the bond can be continuous (e.g., FIG. 8A) or discontinuous (e.g., FIG. 8B) about the perimeter of the compartment. If desired, the first porous outer layer, second porous outer layer and the at least one inner porous layer can be further bonded in a plurality of bonding locations within the perimeter to help maintain uniformity of the powder within the pouch (e.g., FIG. 8(C)). The plurality of bonding locations within the perimeter can include, for example, one or more of (i) a plurality of point bonds across the area defined by the perimeter (e.g., FIG. 8(D)), (ii) a plurality of linear bonds across the area defined by the perimeter (e.g., FIG. 8(E)), (iii) continuous or discontinuous bonds forming a quilted grid pattern within the perimeter (e.g., FIG. 8(F)), (iv) rows of offset dots within the perimeter (e.g., FIG. 8(D)), (v) continuous or discontinuous bonds forming a pattern of repeating hexagons within the perimeter (e.g., FIGS. 8(A), 8(B)). Any desired pattern can be formed, for example, with solid lines, dashed lines, dotted lines, and combinations thereof. For example, a bond pattern can be formed within the perimeter from rows of offset dashes along three different orientations (FIG. 8(B)). The rows of dashes can be angularly offset from each other, such as by about sixty degrees, or any other desired angle. In another embodiment, the bonding locations within the perimeter can be formed by rows of serpentine shapes (e.g., FIG. 8(G)). If desired, the serpentine shapes can be arranged in a herringbone-like pattern.

Filtration Devices

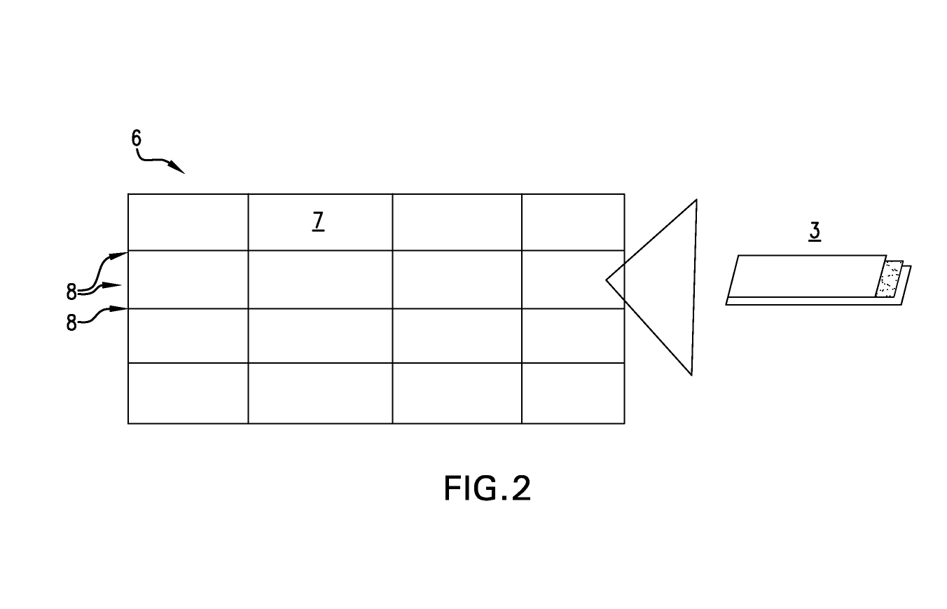

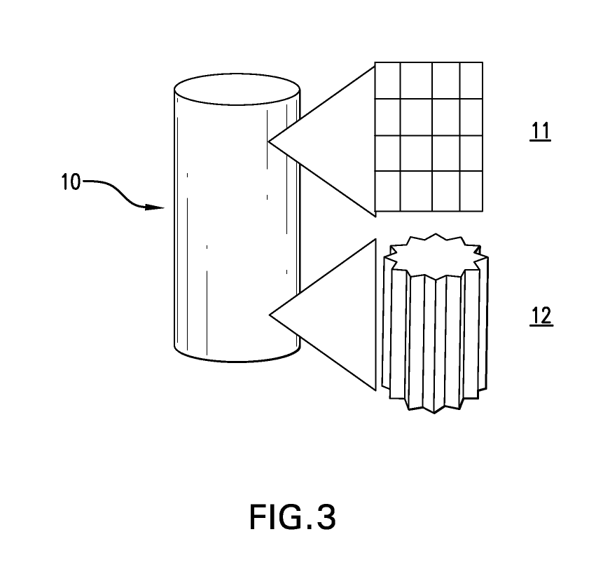

The filter elements can be used to assemble filtration devices, which in turn can include, but are not limited to, lenticular stacks, capsules, spun wound or pleated cartridges, or other enclosed self-contained filter designs. For purposes of illustration, FIGS. 1-2 depict a sandwiched construction 3 of outer layers 4 and inner layer 5 bonded along bond lines 8 to form filter zones 7 containing active filter aid materials. By way of further example, FIG. 3 illustrates a enclosed filter device 10 incorporating the filter. A spiral wound configuration 11 is illustrated with the joined filter areas, as is a pleated filter configuration 12. These filtration designs offer improved filtration operations as compared to wet laid filters due to shorter set up or changeover times, improved operator safety as the high temperatures or harmful liquids to be filtered are generally not exposed to the operator or environment, and the final filter after use can easily be handled with minimal fluid losses, exposure to the operator, or handling a wet, dirty used filter.

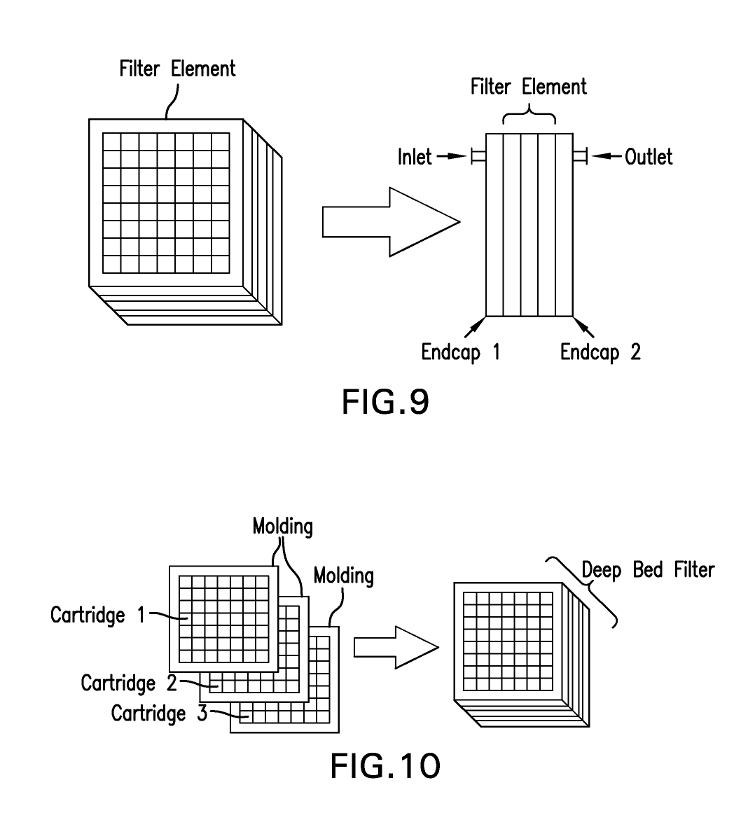

As will be appreciated, various forms and geometries of filters can be provided in accordance with the present disclosure. For example, implementations of a pleated filter are provided herein including one or more pleated filter elements as described herein. Each pleat can include at least one compartment for containing the filter aid material within the interstices of the high loft nonwoven material. The pleated filters can be provided in any desired shape or geometry, such as a conical shape, cylindrical shape, a planar shape, or any other desired shape. Insert molded filter cartridges of any desired shape (e.g., generally round, rectangular, square, oval, etc.) can be provided including a filter element as described herein wherein an insert molding is molded over the filter element, and further wherein the overmold includes fastening bosses or openings for holding the filter element in place, as well as one or more gaskets, flow passages, and the like (e.g., FIG. 9). In the embodiment of FIG. 9, the flow passages are defined between the inlet and the outlet, and gaskets, if desired can be disposed between individual filter elements, preferably about the injection molded periphery of the filter elements, which surround the portion of the filter element including the active filter aid.

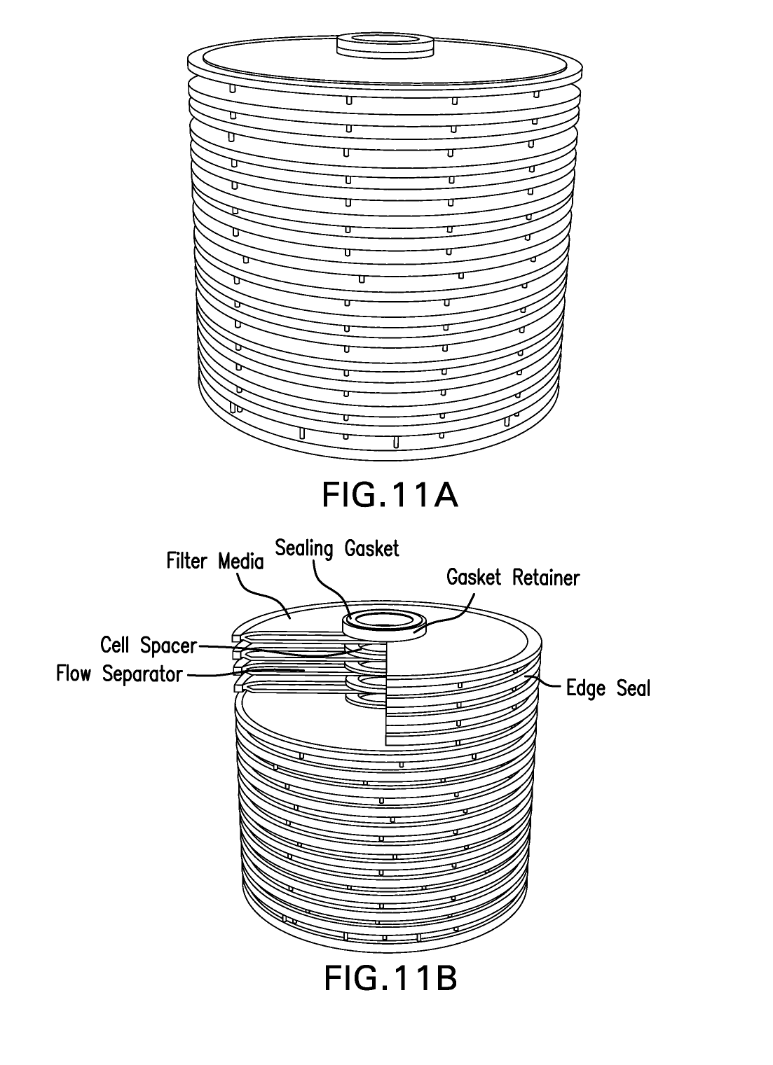

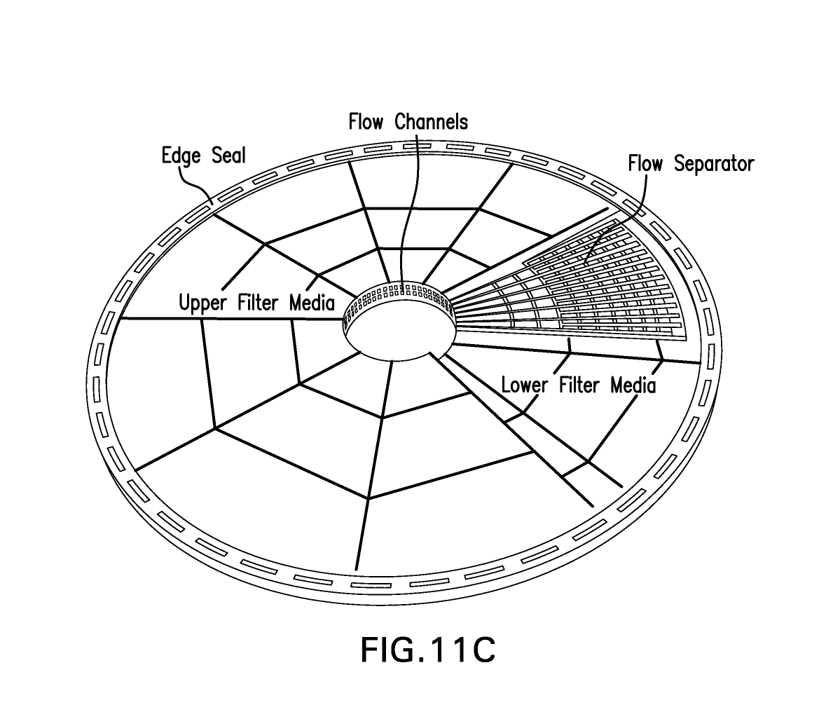

The disclosure also provides embodiments of a deep bed filter (e.g., FIG. 10) including a plurality of filter elements as described herein that are arranged in series and bonded together about a periphery. The filter elements can be bonded together via ultrasonic welding, vibration welding or other suitable heat bonding technique(s). If desired, each filter element can include an insert molded filter cartridge, wherein the filter can be formed by joining the injection molded portion of each filter cartridge to an adjacent filter cartridge, such as via vibration welding or other suitable heat bonding techniques. In accordance with another aspect, a lenticular filter stack including a plurality of filter elements as described herein is also provided (e.g., FIGS. 11A-11C). FIG. 11A illustrates a lenticular filter stack generally, which includes a plurality of vertically stacked cells. Flow is directed radially inwardly between the circumferential edges of adjacent cells, axially through filter media on each side of the cell, and then radially inwardly to a central tube that receives the filtered fluid. FIG. 11B illustrates a cutaway view of the stack illustrating these components in more detail, and FIG. 11 C illustrates a cutaway view of one of the cells, illustrating the two toroidal shaped filter elements (an upper filter media and a lower filter media), each bearing a seal line pattern resembling a spider web to divide the filter element into a plurality of compartments that may contain a suitable filter aid within a high loft non-woven material disposed between two barrier layers, a flow separator that separates the filter elements from each other, and permits the flow to pass through the filter elements and flow radially inwardly into the center tube. It will be appreciated that any desired seal line pattern can be used, such as those depicted in FIGS. 8A-8G.

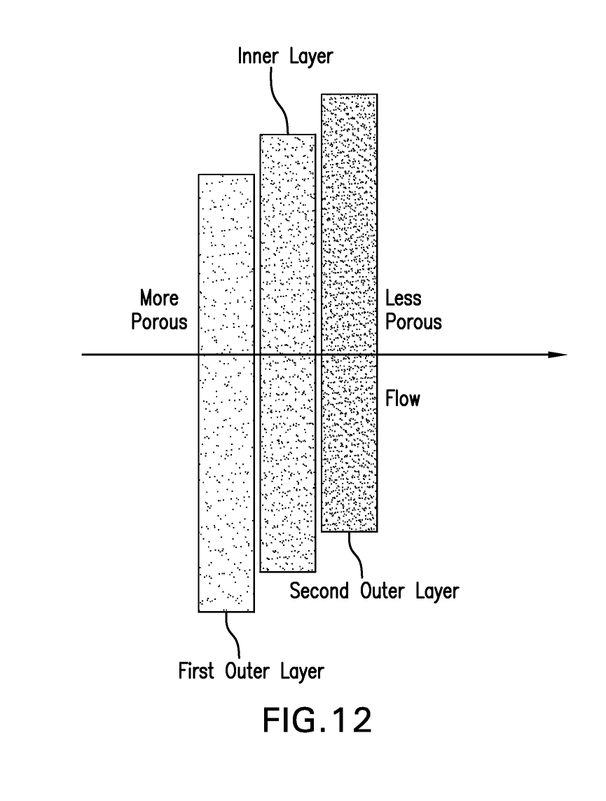

In some implementations, the filter element can have a pore size gradient across its thickness from an outer region of the filter to an inner region of the filter (e.g., FIG. 12). For example, the average pore size or porosity in a first outer layer of the filter can be larger than an average pore size or porosity of an inner layer of the filter. If desired, the average pore size or porosity of the first porous outer layer can be larger than the average pore size of the second porous outer layer, such as to capture large particles in the first porous outer layer first, permitting the second porous outer layer to capture smaller particles.

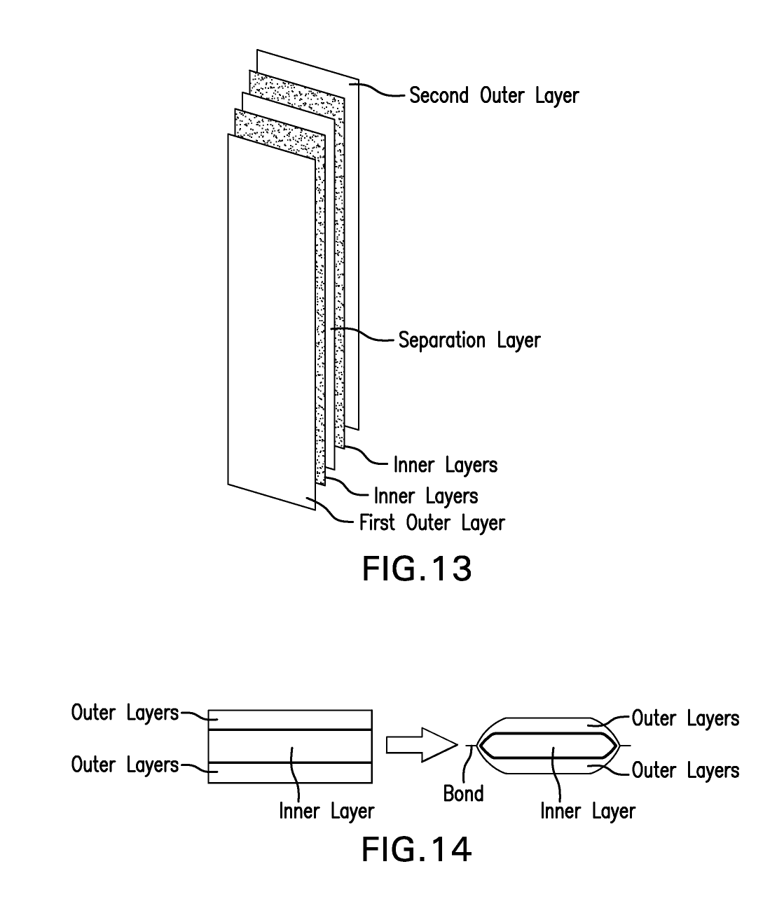

In some embodiments, the filter element can include a plurality of inner layers disposed between the first porous outer layer and second porous outer layer (e.g., FIG. 13). If desired, two adjacent inner layers can be separated by a separation layer including a sheet of porous nonwoven material. Two or more of the inner layers can be provided with differing filter aid materials, if desired. In some implementations, the separation layer can include an average pore size that is smaller (or larger) than the average particle size of filter aid materials in the at least two inner layers, as desired.

In some implementations, the first porous outer layer and second porous outer layer of the filter element can be under tension imparted by compression of the high loft non-woven material of the at least one inner layer (e.g., FIG. 14). The compression of the high loft non-woven material can result in a filter element that is thinner than the nominal thickness of the high loft non-woven material. For example, the filter element can have an overall thickness that can be less than about ninety five percent, ninety percent, eighty five percent, eighty percent, seventy five percent, or seventy percent of the nominal thickness of the high-loft nonwoven material. The high loft non-woven material can be compressed to between about ten and ninety five percent of its nominal thickness in the resulting filter element, in any desired increment of about one percent. Such compression can help trap and substantially immobilize the filter aid material.

### EXAMPLES

The following are illustrative examples of filter elements made in accordance with the disclosure, or aspects thereof. The following test methods were used in the Examples:

Caliper Testing:

Samples were measured for thickness using an Emveco caliper gauge. Samples were measured within the bonded area in multiple locations, and an average of the measurements was recorded in mil.

At least one of the first porous outer layer and the second porous outer layer can have a nominal thickness between about one mil and about twenty mils in any desired increment of about one mil. In a further embodiment, the thickness can be between about three mils and about twelve mils in any desired increment of about one mil.

Basis Weight Testing:

After samples were formed, the entire pouch sample was weighed in grams on a scale capable of weighing to 0.001 g. The area of the pouch sample was measured and converted to square meters and the weight of the pouch was divided by the area. Basis weight was recorded in grams per square meter (gsm). A detailed description of the testing procedure is appended to U.S. Provisional Patent Application Ser. No. 61/981,663, filed Apr. 18, 2014.

The high-loft nonwoven material can have a basis weight, for example, between about 2.0 oz/yd² and about 10.0 oz/yd² in any desired increment of 0.1 oz/yd², for example. In some embodiments, the high-loft nonwoven material can have a basis weight between about 5.0 oz/yd² and about 8.0 oz/yd². At least one of the first porous outer layer and the second porous outer layer can have a basis weight, for example, between about 0.8 oz/yd² and about 40.00 oz/yd² in any desired increment of 0.1 oz/yd². The entire filter element can have a basis weight, for example, between about 100.0 and about 2500.0 grams per square meter, in any desired increment therebetween of one gram per square meter.

Water Flow Rate Testing:

A cake of filter aid sample was disposed on top of the nonwovens described in this example at a loading of approximately 0.190 lbs/ft² within a flow rate test apparatus. A fixed volume of water (1000 ml) was passed through the cake and the nonwoven layers at a set pressure of about 10 psi and the flow rate was determined by the amount of time it took to pass the volume of water through the pad. The temperature of the water used during the test was measured and the results were corrected to 70° F. by means of a temperature correction factor. Results are reported in gpm/ft² or Darcys. A detailed description of the testing procedure, specially modified to accommodate embodiments of the disclosure, is appended to U.S. Provisional Patent Application Ser. No. 61/981,663, filed Apr. 18, 2014.

The filter element can have a water permeability therethrough between about 0.5 gpm/ft² and about 200 gpm/ft² within the perimeter at a water temperature of 70° F. with a pressure differential of 10 psi across the filter element, and in any increment therebetween of about 0.1 gpm/ft². The disclosure similarly provides, in some implementations, an edible oil filter including a filter element having a water permeability therethrough between about 80 gpm/ft² and about 120 gpm/ft² within the perimeter at a water temperature of 70° F. with a pressure differential of 10 psi across the filter element, and in any increment therebetween of about 0.1 gpm/ft². The disclosure further provides embodiments of a coarse liquid filter including a filter element having a water permeability therethrough between about 7.5 gpm/ft² and about 140 gpm/ft² within the perimeter at a water temperature of 70° F. with a pressure differential of 10 psi across the filter element, and in any increment therebetween of about 0.1 gpm/ft².

The disclosure also provides a clarifying liquid filter including a filter element having a water permeability therethrough between about 1.60 gpm/ft² and about 9.30 gpm/ft² within the perimeter at a water temperature of 70° F. with a pressure differential of 10 psi across the filter element, and in any increment therebetween of about 0.1 gpm/ft². Moreover, the disclosure also provides a sterile pre-membrane liquid filter including a filter element having a water permeability therethrough between about 0.40 gpm/ft² and about 2.00 gpm/ft² within the perimeter at a water temperature of 70° F. with a pressure differential of 10 psi across the filter element, and in any increment therebetween of about 0.1 gpm/ft².

Comparative Oil Filtration Testing:

About 900 mL of used oil (obtained from local restaurants) was stirred on a stir plate for about 5 minutes to ensure homogeneity of the sample. The oil was then split into three approximately equal samples to be used for testing; one sample as a control and the other two samples for recirculation testing. One of the oil samples was directed through a wet laid filter sample and the other oil sample was directed through a dry formed filter in accordance with the present disclosure. All samples were heated to 148° C. and were stirred at 250 rpm. To form the nonwoven sample, the base nonwoven layer (outer substrate layer) was placed in the sample holder followed by a layer of high-loft nonwoven material described elsewhere in this example. The active material was then added followed by the top layer of outer substrate nonwoven material. The heated oil was than recirculated through the filter samples at about 15 ml/minute for 30 minutes before collecting approximately 100 ml of filtered oil for testing.

Free Fatty Acid (“FFA”) Removal:

Filtered oil was tested against control oil utilizing the titration method outlined in A.O.C.S. Official Method No. CA5a-40 (appended to U.S. Provisional Patent Application Ser. No. 61/981,663, filed Apr. 18, 2014). The results obtained were expressed in terms of percent of oleic acid in the oil. The percentage of free fatty acids removed was calculated from the amount of oleic acid in the control oil sample compared to the amount in the filtered oil samples.

Soap Testing:

Filtered oil and the control oil were tested for soaps utilizing a Foodlab fat cdR analyzer (user manual appended to U.S. Provisional Patent Application Ser. No. 61/981,663, filed Apr. 18, 2014). The soap testing followed the procedure outlined in the cdR FOODLAB fat Analysis methods booklet on page 12 (appended to U.S. Provisional Patent Application Ser. No. 61/981,663, filed Apr. 18, 2014). Results were recorded in parts per million.

Color Testing:

Filtered oil and the control oil had a color analysis performed on them utilizing a HACH DR4000U Spectrophotometer (user manual appended to U.S. Provisional Patent Application Ser. No. 61/981,663, filed Apr. 18, 2014). A blank cuvette was used as the baseline for testing and all samples were scanned across a range of wavelengths. Absorbance readings were recorded at wavelengths of 460 nm, 550 nm, 620 nm, and 670 nm. The photometric index was then calculated based on the absorbance values at these wavelengths. Percent color change was calculated using the formula:

((PI_{control}−PIₛₐₘₚₗₑ)/PI_{control})×100. (1)

A detailed description of the testing procedure (AOCS Official Method Cc 13c-50) is appended to U.S. Provisional Patent Application Ser. No. 61/981,663, filed Apr. 18, 2014.

Filter Life and Efficiency Testing:

A mixed model stream challenge of combined Ink and 0-3 micron Test Dust provided a turbidity of 125 NTU, as measured on a Hach 2100N Turbidimeter (user manual appended to U.S. Provisional Patent Application Ser. No. 61/981,663, filed Apr. 18, 2014). The challenge stream was passed through a 2 inch diameter filter sample at a flow rate of 1.0 gpm/ft², and turbidity, pressure and time were recorded until a differential pressure of +10 psi was reached. Throughout the test the filtrate was collected and a composite turbidity was determined. The percent retention was calculated using the following formula:

((initial turbidity−composite turbidity)/initial turbidity)*100.

### Example 1

### Edible Oil Depth Filter

The outer layers of the filter were formed from a polyester spunbond meltblown spunbond (SMS) nonwoven web material (Product No. FM-200 obtained from Midwest Filtration, Cincinnati, Ohio, data sheet appended to U.S. Provisional Patent Application Ser. No. 61/981,663, filed Apr. 18, 2014) having a nominal thickness of 7 mil, a basis weight of 1.80oz/yd², and an air permeability of 50 cfm/ft². A photomicrograph at 100× of this material is appended hereto in FIG. 4. This material has a sufficiently small pore size to substantially contain the active ingredient used. The inner layer disposed between the outer layers was a high-loft multi-ply spunbond polyester nonwoven material (Uniloft 675, also obtained from Midwest Filtration, Cincinnati, Ohio, data sheet appended to U.S. Provisional Patent Application Ser. No. 61/981,663, filed Apr. 18, 2014) with a nominal thickness of 0.25 inches, a basis weight of 6.75 oz/yd², and an air permeability of 800 cfm/ft². This illustrative high-loft nonwoven was used to provide depth in the resulting filter element and maintain a high enough flow rate to allow fluid to pass through the filter element at a reasonable rate. The active filter aid (synthetic magnesium silicate) was dispersed in the nonwoven composite. The purpose of the magnesium silicate is to lower the contaminants in the used oil (e.g., free fatty acids, polars, and soaps) while also altering the color back to near its original color.

Ultrasonic bonding was used to join the outer layers to each other through the inner nonwoven layer. These lab-scale samples were bonded using a SeamMaster SM86 ultrasonic bonder (from Sonobond Ultrasonics, West Chester, Pa.; user manual appended to U.S. Provisional Patent Application Ser. No. 61/981,663, filed Apr. 18, 2014). To assemble the stack, a first outer layer and the center high-loft polyester layer were first laid down. The magnesium silicate powder was then deposited onto the highloft polyester layer to provide a loading of about 0.190 lbs/ft². The top outer layer was then laid on top of the high loft nonwoven layer containing the particulate, and the resulting stack was then bonded together ultrasonically. Bonds were formed along all four outside edges of the stack, resulting in a pouch containing active material dispersed within interstices of the high loft nonwoven. Photomicrographs of the nonwoven material without and with magnesium silicate dispersed therein is presented in FIGS. 5 and 6, respectively. While additional bonds could have been formed within the boundaries of the initial bonds in order to maintain some uniformity of the powder within the pouch, this was not performed in this test. Control settings of the ultrasonic bonder mentioned above used to form a suitable bond were as follows: Output—2, Speed A—1, Speed B—1. Prior to sealing the edges, equipment was set to ensure that the pattern wheel just came into contact with the horn.

Initial flow testing as described above yielded results of 86.12 gpm/ft² which is equivalent to 5.35 Darcys. Basis weight of the pouch was measured at 1129 gsm, and the thickness was determined to be 291.2 mil.

Comparative performance testing was conducted after recirculating used edible oil through the pouch filter sample as described above, along with a filter control pad, as described in U.S. Provisional Patent Application Ser. No. 61/981,663, filed Apr. 18, 2014. Test methods for oil performance included free fatty acid analysis, soap and color analysis. The pouch filter sample removed 12.21% of free fatty acids from the oil, while giving a color change of 69.90%, and reducing the soap content from 18 ppm to <1 ppm. The control sample removed 10.07% of free fatty acids from the oil, while giving a color change of 670.80%, and reducing the soap content from 18 ppm to <1 ppm.

### Example 2

### Edible Oil Pad with >80% Powder Loading

The components used in this Example 2 are the same components as used in Example 1 above. Prior to assembling the stack of materials, each of the nonwoven layers was cut to a size of 5 inches by 8 inches. The samples were then marked 0.25 inches from all edges to denote where the welds would occur. The samples were then weighed. Based on the dimensions of the nonwovens, within the denoted marks for the welds, the amount of powder needed to provide a loading of 0.377 lbs/ft² was calculated. The pad was then constructed as described in Example 1. The resulting powder loading of the sample was 0.325 lbs/ft². This construction produced a pad with 80.7% powder by weight. Initial flow testing yielded results of 52.92 gpm/ft² which is equivalent to 3.29 Darcys. Basis weight was measured at 1659 gsm, and thickness was determined to be 358.8 mil.

### Example 3

### Liquid Depth Filter with Diatomaceous Earth

The nonwoven components of this Example 3 are the same as used in Example 1 and Example 2 above. The preferred filter aid used in this example is a calcined diatomaceous earth, in this case, Celite® 577 filter aid (obtained from Imerys Filtration Materials, San Jose, Calif.). The filter aid provides additional surface area and provides depth to the filter to enhance the filtration properties of the filter. A depiction of this material deposited onto the high loft nonwoven material is provided in FIG. 7.

The nonwoven layers used in this Example were measured out to 6 in by 6 in and were marked for powder loading in the center 5 inch by 5 inch portion of the high loft nonwoven. The powder was then loaded in the pad to produce similar powder loading to current specifications of a Gusmer Enterprises produced filter sheet (Gusmer Enterprises Inc., Waupaca, Wis.). The nonwoven layers were than bonded along the markings at 5 inch by 5 inch to envelop the powder.

Initial flow testing yielded results of 9.25 gpm/ft² which is equivalent to 0.57 Darcys. Basis weight was measured at 1007 gsm, and thickness was determined to be 276.9 mil. Filter life and efficiency testing resulted in filter life of 17 minutes and a composite pool turbidity of 17 NTU. With a starting challenge turbidity of 125 NTU filter retention was 86.4%.

### Example 4

### Multiple Pass Oil Filtration

In this Example, a number of the aforementioned tests were repeated, but using different filter element samples and a different oil sample.

### Filter Element Formation

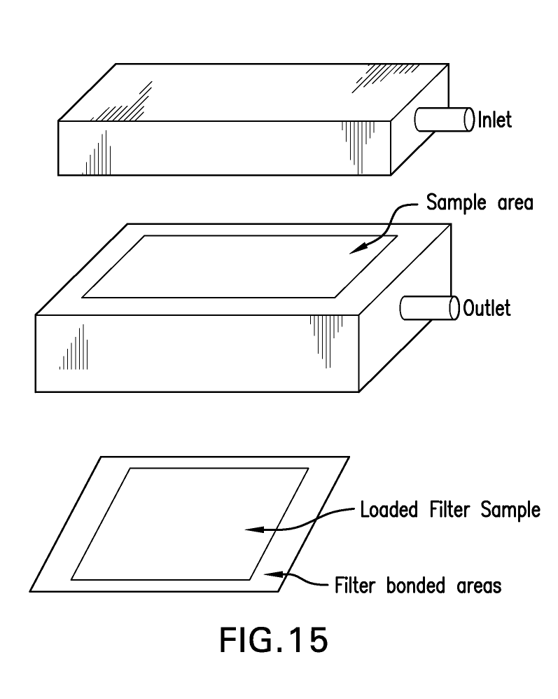

Three-inch square (3″×3″) nonwoven samples were cut and weighed (1-Uniloft 675; 2-FM 200) for building two dry-formed test filter elements to be compared to an incumbent—a traditional wet-laid filter element. The sample holder (FIG. 15) was configured to expose a 2.0 inch square filter element against the oncoming flow. The filter elements were each about 2.5 inches square in overall dimension when installed in the sample holder.

A first dry-formed filter element was assembled using 2.041 grams of magnesium silicate filter aid powder to achieve a similar powder loading to a two-inch square sample of the wet laid incumbent. Three sides of the pouch were welded together on the bench scale ultrasonic welder (described herein above). The magnesium silicate powder was added, and the final side was welded closed, yielding a 2.0 inch square compartment and a filter element that was about 2.5 inches square overall. The final weight of the construction was than taken. This was considered “Sample A”. This powder loading was intended to provide the same loading per square inch as a two-inch square portion of the incumbent pad.

A second dry-formed filter element, “Sample B”, was assembled using 3.185 grams of magnesium silicate filter aid powder to achieve a higher powder loading than Sample A. Specifically, the amount of filter aid was increased to match a particulate loading of a 2.5-inch square sample of the incumbent, since it was possible that oil could be treated by the perimeter region of the 2.5 inch square surface area of the incumbent filter pad, even though only a 2.0 inch square portion of it was directly exposed to the flow. The seal lines of Samples A and B had the same dimensions, however, to define a two-inch square compartment in each sample, wherein the local loading of particulate per square inch of Sample B was higher than Sample A.

The edges of the dry formed samples were trimmed in order to fit the samples into the sample holder for the testing. The initial extra width of the bond area was used in order to help create a better seal during testing.

TABLE 1
Non-Woven Material Weights (Sample A)

| | Weight | | |
|---|---|---|---|
| | of | Basis | |
| | 3″ × 3″ | Weight | Area |
| Nonwoven | (g) | (gsm) | 3″ × 3″ (m²) |
| FM 200(1) | 0.396 | 68.200 | 0.00581 |
| FM 200(2) | 0.383 | 65.961 | |
| Uniloft 675 | 1.204 | 207.356 | |
| Pouch | 3.989 | 4.024 | |

TABLE 2
Non-Woven Material Weights (Sample B)

| | Weight | | |
|---|---|---|---|
| | of | Basis | |
| | 3″ × 3″ | Weight | Area |
| Nonwoven | (g) | (gsm) | 3″ × 3″ (m²) |
| FM 200(1) | 0.382 | 65.789 | 0.00581 |
| FM 200(2) | 0.366 | 63.033 | |
| Uniloft 675 | 1.331 | 229.228 | |
| Pouch | 5.202 | 5.264 | |

TABLE 3
Weights for Testing
(B.W.—Basis Weight (g/m²))

| | Uniloft | | | Total | Filter Aid | Total | |
|---|---|---|---|---|---|---|---|
| | weight | FM 200 (2) | FM 200 (1) | Nonwoven | Weight | Pouch | % |
| | (Calculated) | (Calculated) | (Calculated) | Weight | Needed | Weight | Powder |
| | (g) | (g) | (g) | (g) | (g) | (g) | Loading |
| A | 0.535 | 0.170 | 0.176 | 0.881 | 2.041 | 2.922 | 69.84 |
| | (2″ × 2″ | (2″ × 2″ | (2″ × 2″ | | | | |
| | calculated) | calculated) | calculated) | | | | |
| B | 0.924 | 0.254 | 0.275 | 1.453 | 3.185 | 4.638 | 68.66 |
| | (2.5″ × 2.5″ | (2.5″ × 2.5″ | (2.5″ × 2.5″ | | | | |
| | calculated) | calculated) | calculated) | | | | |

Each pouch sample (A and B) had a powder loading of 790 g/m², or 0.162 lbs/ft². Sample weights in the above tables for oil testing are calculated weights based on the basis weight of each three inch square sample weighed prior to pouch formation. The area of the pouch to which the powder is added to is two inches square, so the weight is calculated based on the area for Sample A. Sample B loads the amount of powder that would be loaded into a 2.5″ square sample into the 2″×2″ area. This was done as indicated above to take into account the extra powder that the incumbent pad would have that may come into contact with the oil.

Oil Testing

1500 mL of oil was stirred and heated to 148° C. When this oil temperature was reached, the oil was separated into three 500 mL samples for testing. An additional 300 mL was also heated to act as the control. The control oil was mixed back and forth with the aforementioned 1500 mL that was heated in order to mix all of the samples evenly. The control oil was heated and stirred on its own hotplate for the entire filtration experiment.

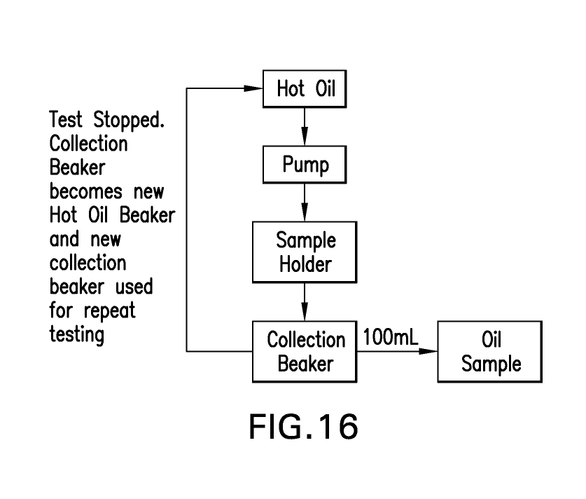

An experimental procedure and apparatus were established for each run (FIG. 16) including a peristaltic pump that took up source oil from each of the three oil samples and directed the oil under positive pressure through each of three sample holders through each of the three filters. The pump used was a ColeParmer MasterFlex™ L/S Economy Drive with MasterFlex™ L/S Easy Load Heads (Model 7518-00). The tubing used was MasterFlex™ 14 (10.6 mm ID, 0.06 in ID) material (FDA Compliant Viton™ polymer). The tubing was used in five foot lengths from the heated oil to the sample holder, and the sample was routed directly into a beaker from the sample holder.

For a first run, 500 ml of oil was directed through each of the incumbent, Sample A and Sample B. 100 ml was set aside from each filtered sample for testing. This procedure was repeated two more times with each of the three samples, resulting in three ˜100 ml samples to be tested for removal of free fatty acids, soaps and color change. These tests were carried out using the same equipment and techniques as the earlier Examples herein. Table 4 below summarizes the results of free fatty acid removal and soap removal testing and Table 5 summarizes color measurement. “INC” refers to the incumbent wet-laid filter that was tested.

TABLE 4
Free Fatty Acid Titration and Soap Removal

| | | | Nor- | | % | | |
|---|---|---|---|---|---|---|---|
| | Sample | Alkali | mality | % | FFA | | |
| | Mass | used | of | Oleic | Re- | | Soaps |
| Sample | (g) | (mL) | Alkali | Acid | moved | Sample | (ppm) |
| Control | 28.205 | 15.4 | 0.1 | 1.54 | | Control | <1 |
| Pass 1 | 28.208 | 14.7 | 0.1 | 1.47 | 4.56 | Pass 1 | <1 |
| INC | | | | | | INC | |
| Pass 2 | 28.209 | 14.8 | 0.1 | 1.48 | 3.91 | Pass 2 | <1 |
| INC | | | | | | INC | |
| Pass 3 | 28.207 | 14.9 | 0.1 | 1.49 | 3.25 | Pass 3 | <1 |
| INC | | | | | | INC | |
| Pass 1 | 28.211 | 14.9 | 0.1 | 1.49 | 3.27 | Pass 1 | <1 |
| Sample | | | | | | Sample | |
| A | | | | | | A | |
| Pass 2 | 28.203 | 14.8 | 0.1 | 1.48 | 3.89 | Pass 2 | <1 |
| Sample | | | | | | Sample | |
| A | | | | | | A | |
| Pass 3 | 28.205 | 14.8 | 0.1 | 1.48 | 3.90 | Pass 3 | <1 |
| Sample | | | | | | Sample | |
| A | | | | | | A | |
| Pass 1 | 28.209 | 14.9 | 0.1 | 1.49 | 3.26 | Pass 1 | <1 |
| Sample | | | | | | Sample | |
| B | | | | | | B | |
| Pass 2 | 28.200 | 14.7 | 0.1 | 1.47 | 4.53 | Pass 2 | <1 |
| Sample | | | | | | Sample | |
| B | | | | | | B | |
| Pass 3 | 28.207 | 14.7 | 0.1 | 1.47 | 4.55 | Pass 3 | <1 |
| Sample | | | | | | Sample | |
| B | | | | | | B | |

TABLE 5
Color Testing
(baseline of empty cuvette prior to testing sample)

| | | | | | | Color |
|---|---|---|---|---|---|---|
| | 460 nm | 550 nm | 620 nm | 670 nm | | Change |
| Sample | (ABS) | (ABS) | (ABS) | (ABS) | PI | (%) |
| Control | 1.895 | 0.786 | 0.542 | 0.485 | 52.21 | |
| Pass 1 INC | 1.247 | 0.269 | 0.094 | 0.041 | 21.92 | 58.02 |
| Pass 2 INC | 1.237 | 0.259 | 0.088 | 0.036 | 21.24 | 59.31 |
| Pass 3 INC | 1.247 | 0.267 | 0.095 | 0.043 | 21.71 | 58.42 |
| Pass 1 Sample A | 1.282 | 0.294 | 0.111 | 0.056 | 23.56 | 54.87 |
| Pass 2 Sample A | 1.254 | 0.273 | 0.096 | 0.042 | 22.23 | 57.41 |
| Pass 3 Sample A | 1.238 | 0.262 | 0.088 | 0.035 | 21.51 | 58.80 |
| Pass 1 Sample B | 1.284 | 0.286 | 0.102 | 0.047 | 23.14 | 55.67 |
| Pass 2 Sample B | 1.236 | 0.254 | 0.082 | 0.031 | 20.93 | 59.91 |
| Pass 3 Sample B | 1.242 | 0.253 | 0.082 | 0.031 | 20.87 | 60.03 |

TABLE 6
Summary of Loading of Filter Aid Powder

| | | | | Rate of | Rate of |
|---|---|---|---|---|---|
| | | | | testing | testing |
| | | | Time | based | based |
| | | | needed | on | on |
| | | Oil | for | active | active |
| | Rate | Filtered | filtration | powder | powder |
| Sample | (mL/min) | (mL) | (min) | (lpm/g) | (gpm/g) |
| Sample A, 1st Pass | 15 | 500 | 33.3 | 0.00735 | 0.00194 |
| Sample A, 2nd Pass | 15 | 350 | 23.3 | 0.00735 | 0.00194 |
| Sample A, 3rd Pass | 15 | 250 | 16.7 | 0.00735 | 0.00194 |
| Sample B, 1st Pass | 15 | 500 | 33.3 | 0.00471 | 0.00124 |
| Sample B, 2nd Pass | 15 | 350 | 23.3 | 0.00471 | 0.00124 |
| Sample B, 3rd Pass | 15 | 250 | 16.7 | 0.00471 | 0.00124 |

The rate of testing based on the amount of active powder in the pouch was calculated and presented in Table 6. This characterization of the data can limit any variances that could be caused based on the loading of the powder itself.

As can be seen from the above data, the performance of the dry laid filter samples was comparable with the commercially available wet-laid filter sample. Accordingly, it is appropriate, in further accordance with the disclosure, to characterize the various filter samples in terms of their effectiveness and performance.

Thus, in some implementations, the filter element can be an edible oil filter element that removes between about 0.1% and 5.0% (and in any increment therebetween of about 0.1%) of free fatty acids present in oil circulated through the filter element under positive pressure at a rate of 0.007 (or 0.0047) liters per minute of oil per gram (lpm/g) of active filter aid particles present in the filter element, wherein the oil has between 1.0% and 2.0% of oleic acid prior to treatment.

In further implementations, the filter element can be an edible oil filter element that reduces the photometric index (P.I.) of the oil by between about 10% and about 70% (and any increment therebetween of about 1.0%) from oil circulated through the filter element under positive pressure at a rate of 0.007 (or 0.0047) liters per minute per gram (lpm/g) of active filter aid particles present in the filter element, wherein the oil has a P.I. between 50 and 55 prior to treatment.

In yet further implementations, the filter element can be an edible oil filter element that reduces the soap content of the oil to (or maintains the soap content at) a concentration of less than about 2.0, 1.5, 1.0 or 0.5 parts per million, wherein the oil is circulated through the filter element under positive pressure at a rate of 0.007 (or 0.0047) liters per minute per gram (lpm/g) of active filter aid particles present in the filter element, wherein the oil has a soap level less than about 3 ppm prior to treatment. While the above data show that the starting and ending soap values were <1 ppm, it can be expected that soaps are created during the process of free fatty acid removal that are in turn also removed by the filter elements.

Any version of any component or method step of this disclosure may be used with any other component or method step of this disclosure. The elements described herein can be used in any combination whether explicitly described or not. All combinations of method steps as used herein can be performed in any order, unless otherwise specified or clearly implied to the contrary by the context in which the referenced combination is made. As used herein, the singular forms “a,” “an,” and “the” include plural referents unless the content clearly dictates otherwise. Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

The devices, methods, compounds and compositions of the present invention can comprise, consist of, or consist essentially of elements described herein, as well as any additional or optional steps, ingredients, components, or elements described herein or otherwise suitable. The methods and systems of the present invention, as described above and shown in the drawings, provide for systems and methods with superior attributes to those of the prior art. It will be apparent to those skilled in the art that various modifications and variations can be made in the devices and methods of the present disclosure without departing from the spirit or scope of the disclosure. Thus, it is intended that the present disclosure include modifications and variations that are within the scope of the subject disclosure and equivalents.

What is claimed is:

1. A filter element, comprising;
a) a first porous outer layer formed from a nonwoven material;
b) a second porous outer layer formed from a nonwoven material;
c) at least one inner porous layer formed from a high loft nonwoven material disposed between the first porous outer layer and the second porous outer layer, the high loft nonwoven material having a three dimensional matrix formed by entangled and bonded fibers that cooperate to form a plurality of three dimensional interstices between the fibers to maintain an open and tortuous flow path through the filter element for fluid to traverse; and
d) filter aid particles dispersed in the interstices of the high loft nonwoven material, wherein the first porous outer layer, second porous outer layer and the at least one inner porous layer are bonded about a perimeter to define a compartment for containing the filter aid material within the interstices of the high loft nonwoven material.

2. The filter element of claim 1, wherein the first porous outer layer and second porous outer layer are under tension imparted by compression of the high loft non-woven material of the at least one inner layer.

3. The filter element of claim 1, wherein the bond is discontinuous about the perimeter of the compartment.

4. The filter element of claim 1, wherein the filter element includes a plurality of inner layers disposed between the first porous outer layer and second porous outer layer.

5. The filter element of claim 1, wherein the filter aid particles form more than about seventy five percent of the weight of the filter element.

6. The filter element of claim 1, wherein the filter aid particles form more than about eighty percent of the weight of the filter element.

7. The filter element of claim 1, wherein the filter aid particles form more than about eighty five percent of the weight of the filter element.

8. The filter element of claim 1, wherein the filter aid particles form more than about ninety percent of the weight of the filter element.

9. The filter element of claim 1, wherein the high loft nonwoven material is a polyester high loft nonwoven material.

10. The filter element of claim 1, wherein the filter aid particles have an average particle size that is larger than an average pore size of pores in the first porous outer layer and second porous outer layer.

11. The filter element of claim 1, wherein the first porous outer layer, second porous outer layer and the at least one inner porous layer are further bonded in a plurality of bonding locations within the perimeter to help maintain uniformity of the powder within the pouch.

12. The filter element of claim 1, wherein the plurality of locations within the bonding locations within the perimeter include a plurality of point bonds across the area defined by the perimeter.

13. The filter element of claim 1, wherein the plurality of locations within the bonding locations within the perimeter include a plurality of linear bonds across the area defined by the perimeter.

14. The filter element of claim 11, wherein the plurality of locations within the bonding locations within the perimeter form a grid pattern within the perimeter.

15. The filter element of claim 11, wherein the plurality of locations within the bonding locations within the perimeter form rows of offset dots within the perimeter.

16. The filter element of claim 11, wherein the plurality of locations within the bonding locations within the perimeter form a pattern of repeating hexagons within the perimeter.

17. The filter element of claim 11, wherein the pattern is formed by broken lines.

18. The filter element of claim 11, wherein the pattern is formed by solid lines.

19. The filter element of claim 11, wherein the plurality of locations within the bonding locations within the perimeter form rows of offset dashes within the perimeter along three different orientations.

20. The filter element of claim 11, wherein the plurality of locations within the bonding locations within the perimeter form rows of serpentine shapes within the perimeter.
